(19) United States
(12) Patent Application Publication
(10) Pub. No.: US 2024/0311689 A1
(43) Pub. Date: Sep. 19, 2024

(54) SYSTEMS AND METHODS FOR TRAINING AN ARTIFICIAL INTELLIGENCE CONVERSATION ENGINE

(71) Applicant: MINDLOGIC INC., Seoul (KR)

(72) Inventors: Yongwoo KIM, Seoul (KR); Jinwook KIM, Seoul (KR)

(21) Appl. No.: 18/546,092

(22) PCT Filed: Jul. 22, 2022
(86) PCT No.: PCT/KR2022/010795

§ 371 Date: Aug. 10, 2023

(30) Foreign Application Priority Data
Jul. 26, 2021 (KR) 10-2021-0097761
Dec. 22, 2021 (KR) 10-2021-0184635
Jan. 24, 2022 (KR) 10-2022-0009993

(51) Int. Cl. G06N 20/00; G06T 11/00

(52) U.S. Cl. CPC G06N 20/00; G06T 11/00; G06T 2211/441

(57) ABSTRACT

Disclosed are an artificial intelligence conversation engine learning method and a system thereof, in which response data for conversation data from a conversation counterpart is determined using an artificial intelligence character, a conversation engine is learned using question and answer data, and an artificial intelligence character to which speech and an interesting conversation content have been assigned is generated.

### CROSS-REFERENCE TO RELATED APPLICATION

This application is a U.S. National Phase patent application of International Patent Application Number PCT/KR2022/010795, filed on Jul. 22, 2022, which claims priority to Korean Patent Application Number 10-2022-0009993, filed on Jan. 24, 2022, and Korean Patent Application Number 10-2021-0184635, filed on Dec. 22, 2021, and Korean Patent Application Number 10-2021-0097761, filed on Jul. 26, 2021, the entire contents of all of which are hereby incorporated by reference.

### BACKGROUND

### 1. Field

Aspects of one or more embodiments of the present disclosure relate to systems and methods for training an artificial intelligence (AI) conversation engine and for creating an AI character.

### 2. Description of Related Art

Artificial Intelligence (AI) is revolutionizing business, organization operation, lifestyle, and communication methods. Various informatization projects are being conducted to provide optimal services for fast-changing lifestyle of the modern culture and diverse and ever-changing requirements of customers. Among them, technology related to bigdata and deep learning is currently being developed rapidly and AI technology being applied to real life is implemented in certain fields and is being applied to an intelligent personal service that integrally provides and uses analysis related to specific data and information of various fields specialized for each individual. Currently, interaction between AI and humans is limited but is performed in everyday natural language, that is, in a conversation form. Although it is still at a rudimentary stage, various home appliances connected to a network may be controlled through a conversation method using voice and a search for specific information, a query, and a response may be performed based on knowledge to which deep learning is applied.

The above information disclosed in this Background section is for enhancement of understanding of the background of the present disclosure, and therefore, it may contain information that does not constitute prior art.

### SUMMARY

Example embodiments of the present disclosure provide an AI conversation engine training method and system that may recommend response data suitable for conversation data through an AI character based on the conversation data between a user and a conversation partner.

Example embodiments of the present disclosure provide an AI conversation engine training method and system that may train a conversation engine of an AI character in a conversation direction desired by a user by collecting question and answer data between the AI character and conversation partners that follow the AI character in the conversation direction desired by the user having created the AI character and by applying the collected question and answer data to the conversation engine.

Example embodiments of the present disclosure provide a conversation engine training method and system of an AI character that may train a conversation engine of an AI character in a conversation direction desired by a creator by collecting question and answer data between the AI character and followers that follow the AI character in the conversation direction desired by the creator and by applying the collected question and answer data to the conversation engine.

An objective of the present disclosure is to provide a conversation engine self-training method and system that enables self-learning of an AI character through free conversation by collecting question and answer data that is input from a creator having created the AI character through the AI character in a conversation service between the AI character and followers that follow the AI character and by applying the collected question and answer data to a conversation engine of the AI character.

Example embodiments of the present disclosure provide an AI character creation method and system that may create an AI character by assigning a speech tone and conversation contents of interest through analysis of introduction contents that introduce the AI character.

An artificial intelligence (AI) conversation engine training method according to an example embodiment of the present disclosure includes maintaining a conversation session between a user and at least one conversation partner; generating recommendation data for a response using an AI character selected by the user in response to receiving conversation data from the at least one conversation partner; and determining response data using the recommendation data.

Also, the AI conversation engine training method according to an example embodiment of the present disclosure may further include processing a function of inputting the recommendation data to an input box, a function of modifying the recommendation data input to the input box, a function of deleting the recommendation data, and a function of determining the recommendation data as the response data and transmitting the same to a chat window, according to a voice command of the user; and selecting the AI character or a conversation engine to generate the recommendation data according to a selection of the user.

An AI conversation engine training system according to an example embodiment of the present disclosure includes a provider configured to maintain a conversation session between a user and at least one conversation partner; a generator configured to generate recommendation data for a response using an AI character selected by the user in response to receiving conversation data from the at least one conversation partner; and a determiner configured to determine response data using the recommendation data.

Also, an AI conversation engine training system according to an example embodiment of the present disclosure may further include a controller configured to process a function of inputting the recommendation data to an input box, a function of modifying the recommendation data input to the input box, a function of deleting the recommendation data, and a function of determining the recommendation data as the response data and transmitting the same to a chat window, according to a voice command of the user.

A conversation engine training method of an AI character according to an example embodiment of the present disclosure includes creating an AI character based on an input of a creator; collecting question and answer data of each of the AI character and followers that follow the AI character with respect to an initial question (e.g., a preset initial question); and training the conversation engine by applying the collected question and answer data to a conversation engine of the AI character.

The collecting may include a first operation of providing a first answer of the AI character to the initial question to each of the followers that follow the AI character based on an answer input of the creator; a second operation of receiving a response to the first answer from each of the followers and providing a second answer of the AI character to the response received from each of the followers to each of the followers based on the answer input of the creator; and a third operation of collecting question and answer data in relation to the initial question by repeating the answer (e.g., the first answer and/or the second answer) of the AI character and the response of each of the followers to the answer (e.g., the first answer) of the AI character one or more times (e.g., a predetermined number of times).

The collecting may include, when an answer conversation window is provided from the conversation engine of the AI character with respect to the initial question and the answer conversation window is pushed (e.g., selected or engaged) for a certain period of time (e.g., a certain period of time preset by the creator), executing a function for collecting the question and answer data and collecting the question and answer data.

The second operation may include providing the second answer to each of the followers by inputting the second answer through the answer input of the creator in order to provide a notification to the creator when the response to the first answer is received and to learn the second answer to the response received from each of the followers as an answer desired by the creator through the notification.

A conversation engine self-training method of an AI character according to an example embodiment of the present disclosure includes creating an AI character based on an input of a creator; providing a conversation service between the AI character and a follower that follows the AI character; and training the conversation engine by applying question and answer data of the creator through the AI character in the conversation service to the conversation engine of the AI character.

The training of the conversation engine may include training the conversation engine by automatically collecting the question and answer data that is input from the creator through the AI character with respect to a question and a response of the follower in a state in which an automatic response function of the conversation service is turned OFF and by applying the collected question and answer data to the conversation engine.

The automatic response function may represent a function that allows the AI character to automatically converse with the follower in the conversation service based on the pretrained conversation engine.

An AI character creation method according to an example embodiment of the present disclosure includes setting introduction contents that introduce an AI character to be created based on an input of a user; analyzing the set introduction contents and determining a speech tone and conversation contents of interest to be assigned; and creating the AI character to which the determined speech tone and conversation contents of interest are assigned.

The determining may include determining the conversation contents of interest by applying at least one tag topic or matter of interest set by the user.

The creating may include creating the AI character by combining the determined speech tone and conversation contents of interest in a conversation engine (e.g., a preset conversation engine) or by adding the determined speech tone and conversation contents of interest to the conversation engine (e.g., the preset conversation engine).

According to example embodiments of the present disclosure, the wide range of conversation may be continued between a user and a conversation partner by recommending response data suitable for conversation data through an artificial intelligence (AI) character based on the conversation data between the user and the conversation partner.

According to example embodiments of the present disclosure, it is possible to train a conversation engine of an AI character in a conversation direction desired by a user (creator) by collecting question and answer data between the AI character and conversation partners (followers) that follow the AI character in the conversation direction desired by the user (creator) having created the AI character and by applying the collected question and answer data to the conversation engine and through this, to allow the AI character to have a conversation in a direction desired by the user when conversing with the conversation partner (follower).

According to example embodiments of the present disclosure, it is possible to train a conversation engine in a conversation direction desired by a user (creator) by generating an answer of an AI character based on an answer input of the user (creator) with respect to an initial question (e.g., a preset initial question) and by applying the answer of the AI character to the initial question to the conversation engine.

According to example embodiments of the present disclosure, when an answer of an AI character is pushed (e.g., selected or engaged) for a certain period of time preset by a user (creator) or more on a chat window between the AI character and a conversation partner (follower), it is possible to train a conversation engine in a conversation direction desired by the user (creator) by modifying the answer of the AI character based on an answer input of the user (creator) and by applying conversation contents of the chat window and the modified answer to the conversation engine of the AI character.

According to example embodiments of the present disclosure, by repeatedly training a conversation engine through collection of question and answer data, a conversation technique of an AI character may be improved and the AI character may have a natural conversation with a conversation partner accordingly.

According to example embodiments of the present disclosure, self-learning of an AI character is possible even during a free conversation by collecting question and answer data that is input from a creator having created the AI character through the AI character in a conversation service between the AI character and a follower that follows the AI character and by applying the collected question and answer data to the conversation engine of the AI character. Therefore, it is possible to train the AI character in a conversation direction desired by the user (or creator) and through this, when the AI character converses with the follower in the conversation service in which an automatic response function operates, the AI character may perform an automatic conversation in a direction desired by the creator.

According to example embodiments of the present disclosure, in a conversation service between an AI character and a follower, if an automatic response function is in an ON state, the AI character may converse with the follower based on a pretrained conversation engine and if the automatic response function is in an OFF state, a creator may freely input text and participate in a conversation and question and answer data between the follower and the creator may be collected and applied to train a conversation engine of the AI character.

According to example embodiments of the present disclosure, it is possible to provide an AI character that talks about conversation contents of interest desired by a user in a speech tone desired by the user by assigning the speech tone and the conversation contents of interest through analysis of introduction contents that introduce the AI character and thereby creating the AI character.

According to example embodiments of the present disclosure, it is possible to provide a tag function and to determine conversation contents of interest by applying a tag topic or a matter of interest selected from the tag function or generated and selected by a user from the tag function, and accordingly, to assign the conversation contents of interest or conversation knowledge of interest to which the tag topic or the matter of interest is applied to a conversation engine of an AI character.

The above and other aspects and features of the present disclosure will become better understood through the accompanying drawings, the detailed description, and the claims and their equivalents.

### BRIEF DESCRIPTION OF DRAWINGS

Non-limiting and non-exhaustive embodiments of the present disclosure are described with reference to the following figures, wherein like reference numerals refer to like parts throughout the various views unless otherwise specified.

FIG. 1 illustrates an example of a network environment, according to some embodiments of the present disclosure.

FIG. 2 is a diagram illustrating an example of an internal configuration of an electronic device and a server of FIG. 1, according to some embodiments of the present disclosure.

FIG. 3 is a flowchart illustrating an artificial intelligence (AI) conversation engine training method, according to some embodiments of the present disclosure.

FIG. 4 is a flowchart illustrating an AI conversation engine training method, according to some embodiments of the present disclosure.

FIGS. 5 to 6B illustrate examples of describing a process of collecting question and answer data of an AI character, according to some embodiments of the present disclosure.

FIGS. 7A, 7B and 7C illustrates examples of describing a process of recommending response data of an AI character, according to some embodiments of the present disclosure.

FIGS. 8A and 8B illustrate examples of recommendation data of an AI character, according to some embodiments of the present disclosure.

FIG. 9 is a diagram illustrating a configuration of an AI conversation engine training system, according to some embodiments of the present disclosure.

FIG. 10 is a diagram illustrating a configuration of a conversation engine training system of an AI character, according to some embodiments of the present disclosure.

FIG. 11 is a flowchart illustrating a conversation engine self-training method of an AI character, according to some embodiments of the present disclosure.

FIGS. 12 to 15 illustrate examples of a conversation engine self-training method of an AI character provided through an application, according to some embodiments of the present disclosure.

FIG. 16 is a diagram illustrating a configuration of a conversation engine self-training system of an AI character, according to some embodiments of the present disclosure.

FIG. 17 is a flowchart illustrating an AI character creation method, according to some embodiments of the present disclosure.

FIG. 18 illustrates an example of a user interface for describing an AI character, according to some embodiments of the present disclosure.

FIGS. 19A, 19B and 19C illustrates an example of describing a process of creating a facial image of an AI character, according to some embodiments of the present disclosure.

FIG. 20 illustrates a configuration of an AI character creation system, according to some embodiments of the present disclosure.

### DETAILED DESCRIPTION

Aspects of the present disclosure and methods of accomplishing the same may be understood more readily by reference to the detailed description of one or more embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey aspects of the present disclosure to those skilled in the art. Accordingly, description of processes, elements, and techniques that are not necessary to those having ordinary skill in the art for a complete understanding of the aspects and features of the present disclosure may be omitted.

Unless otherwise noted, like reference numerals, characters, or combinations thereof denote like elements throughout the attached drawings and the written description, and thus, descriptions thereof will not be repeated. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown to facilitate a less obstructed view of these various embodiments and to make the description clear.

In the detailed description, for the purposes of explanation, numerous specific details are set forth to provide a thorough understanding of various embodiments. It is apparent, however, that various embodiments may be practiced without these specific details or with one or more equivalent arrangements.

It will be understood that, although the terms “zeroth,” “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or component is referred to as being “on,” “connected to,” or “coupled to” another element or component, it can be directly on, connected to, or coupled to the other element or component, or one or more intervening elements or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or component is referred to as being “between” two elements or components, it can be the only element or component between the two elements or components, or one or more intervening elements or components may also be present.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, each of the terms “or” and “and/or” includes any and all combinations of one or more of the associated listed items. For example, the expression “A and/or B” denotes A, B, or A and B.

For the purposes of this disclosure, expressions such as “at least one of,” when preceding a list of elements, modify the entire list of elements and do not modify the individual elements of the list. For example, “at least one of X, Y, or Z,” “at least one of X, Y, and Z,” and “at least one selected from the group consisting of X, Y, and Z” may be construed as X only, Y only, Z only, or any combination of two or more of X, Y, and Z, such as, for instance, XYZ, XYY, YZ, and ZZ.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

When one or more embodiments may be implemented differently, a specific process order may be performed differently from the described order. For example, two consecutively described processes may be performed substantially at the same time or performed in an order opposite to the described order.

Any of the components or any combination of the components described (e.g., in any system diagrams included herein) may be used to perform one or more of the operations of any flow chart included herein. Further, (i) the operations are merely examples, and may involve various additional operations not explicitly covered, and (ii) the temporal order of the operations may be varied.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Aspects of one or more embodiments of the present disclosure relate to technology for training an artificial intelligence (AI) conversation engine, and more particularly, to a conversation engine training method and system that may generate recommendation data that responds to conversation data between a user and a conversation partner and may determine response data, a conversation engine training method and system of an AI character that may train a conversation engine of an AI character in a conversation direction desired by a creator by collecting question and answer data between the AI character and followers that follow the AI character in the conversation direction desired by the creator having created the AI character and by applying the collected question and answer data to the conversation engine, and a conversation engine self-training method and system that may self-train a conversation engine of an AI character with data input from a creator by collecting question and answer data that is input from the creator through the AI character in a conversation service between the AI character and followers that follow the AI character and by applying the collected question and answer data to the conversation engine.

Also, the present disclosure relates to an AI character creation method and system that may create an AI character by assigning a speech tone and conversation contents of interest through analysis of introduction contents that introduce the AI character.

Example embodiments of the present disclosure are to train a conversation engine of an artificial intelligence (AI) character in a conversation direction desired by a user by determining response data in such a manner that the AI character generates recommendation data in relation to conversation data based on the conversation data between the user and a conversation partner and by collecting question and answer data between the AI character and conversation partners that follow the AI character in the conversation direction desired by the user, that is, a creator having created the AI character and by applying the collected question and answer data to the conversation engine.

Also, example embodiments of the present disclosure are to train a conversation engine of an AI character in a conversation direction desired by a creator by collecting question and answer data between the AI character and followers that follow the AI character in the conversation direction desired by a user, that is, the creator having created the AI character and by applying the collected question and answer data to the conversation engine.

Further, a conversation engine self-training method and system of an AI character according to an example embodiment of the present disclosure is to self-train a conversation engine of an AI character with data input from a creator by collecting question and answer data that is input from the creator through the AI character in a conversation service between the AI character and a follower that follows the AI character using an online chat server and by applying the collected question and answer data to the conversation engine.

Here, in a conversation service between an AI character and a follower according to an example embodiment of the present disclosure, if an automatic response function is in an ON state, the AI character may automatically converse with the follower based on a pretrained conversation engine and if the automatic response function is in an OFF state, may collect question and answer data that is directly input from a creator through the AI character and may self-train a conversation engine of the AI character in real time.

An online chat server of the present disclosure may create an AI character in a form of a mobile application, may provide a conversation service between the created AI character and a follower that follows the AI character, and may train a conversation engine of the AI character using question and answer data of a creator during a free conversation. Therefore, the creator (or user) may create the creator's own AI character through an application installed in a terminal of the creator, may freely communicate with followers using the created AI character, or may conduct an automatic conversation with the followers using the AI character based on a pre-trained conversation engine through an automatic response function.

The creator (or user) may perform the conversation service through at least one terminal (or electronic device) among the creator's smartphone, desktop personal computer (PC), mobile terminal, personal digital assistant (PDA), laptop, and tablet PC. Here, the present disclosure may receive information according to a selection and input from the user through an application in a terminal of the user and the terminal may include a display in a touchscreen form that may perform an operation of a function (e.g., a predetermined function) set through a screen including a touch-sensing area and may be a device that includes at least one physical button or virtual button. Therefore, types and shapes of the terminal are not limited thereto.

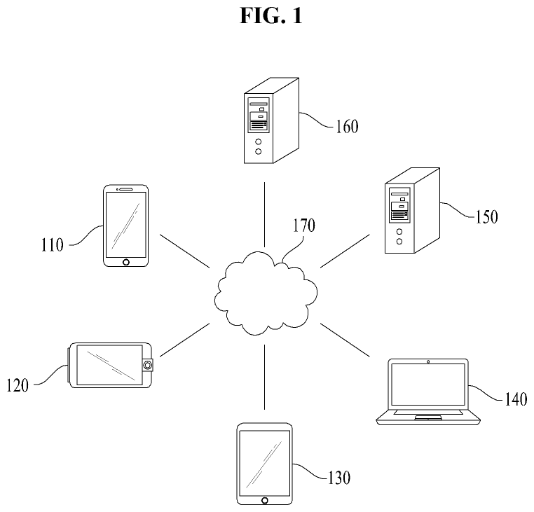

FIG. 1 illustrates an example of a network environment according to an example embodiment of the present disclosure. The network environment of FIG. 1 includes a plurality of electronic devices 110, 120, 130, and 140, a plurality of servers 150 and 160, and a network 170. FIG. 1 is provided as an example only. The number of electronic devices or the number of servers is not limited as illustrated in FIG. 1.

Each of the plurality of electronic devices 110, 120, 130, and 140 may be a mobile terminal that is implemented as a computer device. For example, the plurality of electronic devices 110, 120, 130, and 140 may be a smartphone, a mobile phone, a tablet PC, a navigation, a computer, a laptop computer, a digital broadcasting terminal, a PDA, a portable multimedia player (PMP), a user wearable device, and the like. For example, the first electronic device 110 may communicate with other electronic devices 120, 130, and 140 and/or the servers 150 and 160 over the network 170 using a wireless or wired communication method.

The communication scheme is not limited and may include a communication network (e.g., a mobile communication network, wired Internet, wireless Internet, a broadcasting network) includable in the network 170 and may also include a near field communication between devices. For example, the network 170 may include at least one of networks, such as a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be implemented as a computer device or a plurality of computer devices that provides an instruction, a code, a file, content, a service, etc., through communication with the plurality of electronic devices 110, 120, 130, and 140 over the network 170.

For example, the server 160 may provide a file for installation of an application to the first electronic device 110 connected over the network 170. In this case, the first electronic device 110 may install the application using the file provided from the server 160. Also, the server 160 may receive a service or content provided from the server 150 through connection to the server 150 under control of an operating system (OS) or at least one program (e.g., browser or the installed application) included in the first electronic device 110. For example, when the first electronic device 110 transmits a service request message to the server 150 through the network 170 under control of the application, the server 150 may transmit a code corresponding to a service request message to the first electronic device 110 and the first electronic device 110 may provide content to the user by configuring and displaying a screen according to the code under control of the application.

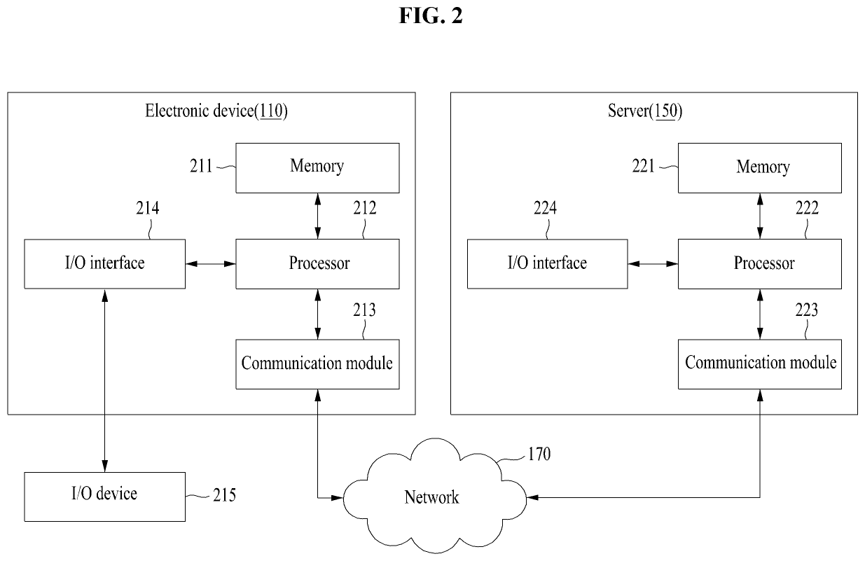

FIG. 2 is a diagram illustrating an example of an internal configuration of an electronic device and a server of FIG. 1. In FIG. 2, description is made using the first electronic device 110 as an example of a single electronic device that is a terminal of a user and the server 150 as a single server that communicates with the terminal of the user. Therefore, in the following, the first electronic device 110 represents the terminal of the user and the server 150 represents the server that communicates with the terminal of the user. Other electronic devices 120, 130, and 140 or the server 160 may have the same or similar internal configuration.

The first electronic device 110 and the server 150 may include memories 211 and 221, processors 212 and 222, communication modules 213 and 223, and input/output (I/O) interfaces 214 and 224, respectively. The memory 211, 221 may include a permanent mass storage device, such as a random access memory (RAM), a read only memory (ROM), and a disk drive, as a computer-readable record medium. Also, an OS or at least one program code (e.g., a code for an application that is installed and executed on the first electronic device 110) may be stored in the memory 211, 221. Such software components may be loaded from another computer-readable record medium separate from the memory 211, 221. The other computer-readable record medium may include a computer-readable record medium, for example, a floppy drive, a disk, a tape, a DVD/CD-ROM drive, a memory card, etc. According to other example embodiments, software components may be loaded to the memory 211, 221 through the communication module 213, 223, instead of the computer-readable record medium. For example, at least one program may be loaded to the memory 211, 221 based on a computer program (e.g., the application) installed by files provided over the network 170 from developers or a file distribution system (e.g., the server 160) providing an installation file of the application.

The processor 212, 222 may be configured to process instructions of a computer program by performing basic arithmetic operations, logic operations, and I/O operations. The instructions may be provided from the memory 211, 221 or the communication module 213, 223 to the processor 212, 222. For example, the processor 212, 222 may be configured to execute received instructions in response to the program code stored in the storage device, such as the memory 211, 221.

The communication module 213, 223 may provide a function for communication between the first electronic device 110 and the server 150 over the network 170 and may provide a function for communication with another electronic device (e.g., a second electronic device 120) or another server (e.g., the server 160). For example, a request (e.g., search request) generated by the processor 212 of the first electronic device 110 based on a program code stored in the storage device such as the memory 211, may be transmitted to the server 150 over the network 170 under control of the communication module 213. Inversely, a control signal, an instruction, content, a file, etc., provided under control of the processor 222 of the server 150 may be received at the first electronic device 110 through the communication module 213 of the first electronic device 110 by going through the communication module 223 and the network 170. For example, a control signal, an instruction, etc., of the server 150 received through the communication module 213 may be transmitted to the processor 212 or the memory 211, and content, a file, etc., may be stored in a storage medium further includable in the first electronic device 110.

The I/O interface 214 may be a device used for interfacing with an I/O device 215. For example, an input device may include a device, such as a keyboard, a mouse, etc., and an output device may include a device, such as a display, for displaying a communication session of an application. As another example, the I/O interface 214 may be a device for interfacing with an apparatus in which an input function and an output function are integrated into a single function, such as a touchscreen. In detail, for example, when the processor 212 of the first electronic device 110 processes an instruction of the computer program loaded to the memory 211, a service screen or content configured using data provided from the server 150 or the second electronic device 120 may be displayed on a display through the I/O interface 214. As in the I/O interface 224, when the processor 222 of the server 150 processes an instruction of the computer program loaded to the memory 221, information configured using data provided from the server 150 may be output.

Also, in other example embodiments, the first electronic device 110 and the server 150 may include the number of components greater than the number of components of FIG. 2. However, there is no need to clearly illustrate many components according to the related art. For example, the first electronic device 110 may include at least a portion of the I/O device 215, or may further include other components, for example, a transceiver, a global positioning system (GPS) module, a camera, a variety of sensors, a database (DB), and the like. In detail, if the first electronic device 110 is a smartphone, the first electronic device 110 may be configured to further include a variety of components, for example, an orientation sensor, an acceleration sensor or a gyro sensor, a camera, various physical buttons, a button using a touch panel, an I/O port, a vibrator for vibration, etc., which are generally included in the smartphone.

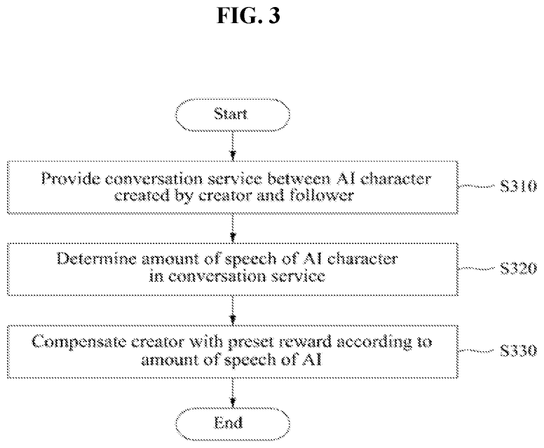

FIG. 3 is a flowchart illustrating an AI conversation engine training method according to an example embodiment of the present disclosure and illustrates a flowchart in a system or a server in which an AI character may generate and recommend recommendation data in relation to conversation data based on the conversation data between a user and a conversation partner and may determine the recommendation data as response data.

Referring to FIG. 3, the AI conversation engine training method according to an example embodiment of the present disclosure maintains a conversation session between a user and a conversation partner (S310). When the user converses with a conversation partner of a creator that is a human or an AI character, operation S310 may maintain the conversation session between the user and the conversation partner in a chat window and may receive conversation data between the user and the conversation partner.

When the conversation data is received in operation S310, recommendation data for a response is generated through the AI character based on the conversation data (S320). In operation S320, the AI character may generate the recommendation data suitable for the conversation data through a trained conversation engine, based on the conversation data. Here, the recommendation data represents a chat message (or conversation message) that includes all of a preemptive message, a response message that is an answer message.

Here, operation S320 is based on generating the recommendation data in an ON state of a response recommendation function, based on a selection of the user. For example, the response recommendation function of generating and recommending recommendation data may be turned ON or turned OFF by the user, and generates the recommendation data through the AI character in an ON state and does not generate the recommendation data in an OFF state. For example, the recommendation data may be generated based on an ON/OFF state of the response recommendation function. The user may select whether the response recommendation function is in the ON state or the OFF state.

The AI character according to an example embodiment of the present disclosure may participate in the conversation session as a conversation participant independent of the user. For example, the AI character may participate in the conversation session as the conversation participant instead of the user or the conversation partner and may exchange conversation messages.

Also, although the AI character according to an example embodiment of the present disclosure does not participate in the conversation session as the conversation participant, the AI character may generate recommendation data for a response by activating the conversation engine of the AI character by the user. Even without the AI character, the present disclosure may generate recommendation data for a response through the conversation engine in response to receiving conversation data from the user and at least one conversation partner. Here, the conversation engine relates to being generated and maintained by learning at least one piece of conversation data through the conversation session between the user and the conversation partner and may be trained even without the AI character and may generate the recommendation data even without the AI character.

When the recommendation data is generated in operation S320, response data is determined using the generated recommendation data (S330). When the response recommendation function is in an ON state, operation S330 may recommend the recommendation data near an input box for inputting a message and a copy icon for inputting the recommendation data may be located near the recommendation data. For example, the recommendation data generated through operation S320 may be recommended using an AI recommendation window and displayed for the user. Therefore, when the user desires to transmit the recommended recommendation data to the chat window as a response message, the user may click the copy icon and input a recommendation message to the input box and then may click a ‘Send’ button located near the input box to transmit the response message to the chat window. Here, when the copy icon is clicked by the user and the recommended recommendation data is input to the input box, the user may modify the corresponding recommendation data in the input box.

Also, when an automatic dispatch function is in an ON state with the response recommendation function according to a selection and input of the user, operation S330 may automatically input the recommendation data that is recommended in the AI recommendation window to the input box regardless of a selection of the user and then determine the recommendation data as response data and may automatically transmit the same to the chat window. Here, depending on example embodiments, the recommendation data automatically input to the input box may be modified by the user and operation S330 may determine the recommendation data modified by the user as the response data.

When the response recommendation function is in an ON state, the AI conversation engine training method according to an example embodiment of the present disclosure may change a display location and color of the AI recommendation window for recommending recommendation data or may change the copy icon in a different icon shape according to a selection of the user. For example, the user may locate the AI recommendation window at the beginning of conversation exchanged in the chat window, not near the input box, and may change a font and color of the generated and recommended recommendation data in a form (e.g., a preferred form) and may also change a corresponding icon.

The AI conversation engine training method according to an example embodiment of the present disclosure may process a function of inputting the recommendation data to an input box, a function of modifying the recommendation data input to the input box, a function of deleting the recommendation data, and a function of determining the recommendation data as the response data and transmitting the same to a chat window, according to a voice command of the user. In detail, the present disclosure may process the aforementioned functions according to the voice command of the user rather than a selection and input of the user, such as touch, button input, and click. For example, if the user commands “Enter recommendation data,” the present disclosure may input the recommendation data recommended in the AI recommendation window to the input box. Also, if the user commands “Delete recommendation data,” the present disclosure may delete the recommendation data recommended in the AI recommendation window.

The AI conversation engine training method according to an example embodiment of the present disclosure may select an AI character that recommends recommendation data according to a selection of the user. The AI character that recommends response data may represent a personality, such as a caring type, a bad boy type, and a courageous type of a person, and the user may select a specific AI character according to a personality of each AI character. Therefore, the selected AI character may generate and recommend recommendation data suitable for a personality characteristic. For example, if the user inputs a message, such as “I'm hungry,” an AI character of a caring type may generate and recommend recommendation data, such as “You must be starving” and “Let's go to have something delicious.”

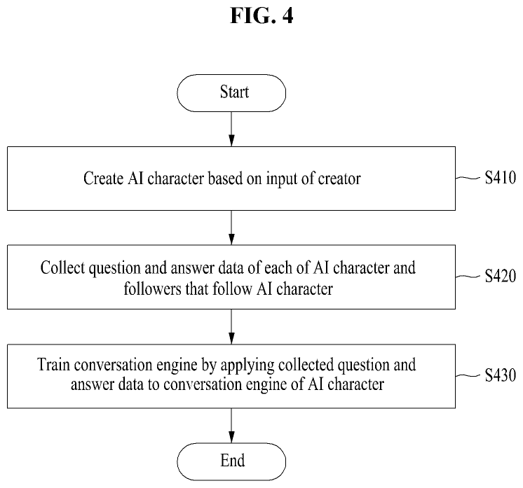

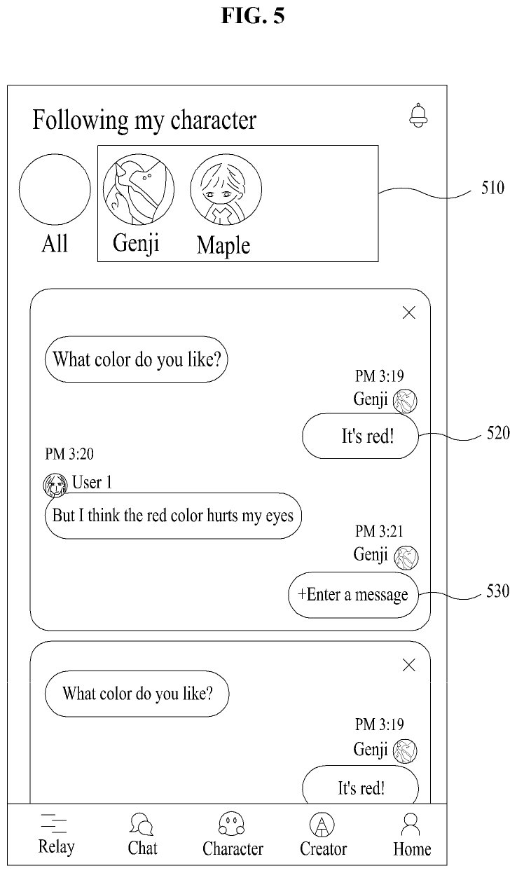

The AI conversation engine training method according to an example embodiment of the present disclosure may train a conversation engine by applying recommendation data in relation to conversation data to the conversation engine of the AI character. A process of training the conversation engine is further described below with reference to FIGS. 4 to 6B.

Here, although the present disclosure describes an example of training a conversation engine of an AI character, it is not limited to presence or absence of the AI character and only the conversation engine may be trained without creating the AI character.

FIG. 4 is a flowchart illustrating an AI conversation engine training method according to an example embodiment of the present disclosure and illustrates a flowchart in a system or a server that may provide a conversation service and may train an AI character in a direction desired by a user that is a creator. Hereinafter, the AI conversation engine training method represents a conversation engine training method of the AI character.

Referring to FIG. 4, the AI conversation engine training method according to an example embodiment of the present disclosure creates an AI character based on an input of a user that is a creator (S410). Hereinafter, the user represents the creator.

Here, in operation S410, the user may create the AI character through an AI character creation function that is provided from a conversation service and a system that may train an AI character conversation engine. For example, in operation S410, because a facial image, a speech tone, a personality, a conversation field of interest (or conversation contents of interest), a name, a gender, character introduction contents, and the like are set by the user, a basic conversation engine (e.g., a preset basic conversation engine) may be trained and the AI character may be created. Here, the AI character created in operation S410 may exchange a conversation with followers (or conversation partners) that are users following the corresponding AI character, with the speech tone and the conversation contents of interest set by the user. Hereinafter, the conversation partner represents the follower.

When the AI character created as above converses with conversation partners using the conversation engine, the method of the present disclosure may train the conversation engine of the AI character such that the AI character may conduct a conversation with an answer method or answer contents desired by the user with respect to an answer method and answer contents with the conversation partners. For example, the method of the present disclosure relates to gradually developing the conversation engine of the already created AI character according to a request from the user and may repeatedly perform such development until the conversation engine of the AI character is completed.

Also, at least one hashtag set by the user may be assigned to the AI character created in operation S410, such that other users may search for the AI character created by the user through a keyword of a conversation field of interest and the like.

For example, if the hashtag of the AI character is set as “#golf” and “#sports” by the user, the corresponding AI character may be retrieved with golf and sports and may be classified into an AI character capable of having a conversation related to golf and sports.

When there are followers (or conversation partners) that follow the corresponding AI character after the AI character is created by the user in operation S410, question and answer data exchanged between the AI character and the conversation partners is collected to additionally train the conversation engine of the AI character (S420).

The conversation partner in the present disclosure may include all of a user capable of creating an AI character rather than the AI character and users capable of performing a conversation with the AI character.

Here, in operation S420, a function for collecting question and answer data may be performed in response to an input or an action of the user. For example, when a “relay” function is provided to an application for a user terminal provided from the present disclosure as a function for collecting question and answer data of the AI character, and when the “relay” function is selected by an input of the user for the corresponding AI character, question and answer data exchanged between the AI character and each of conversation partners may be collected until the “relay” function is completed. Here, an answer provided from the AI character to each of the conversation partners may be provided through conversation of the AI character by the input of the user.

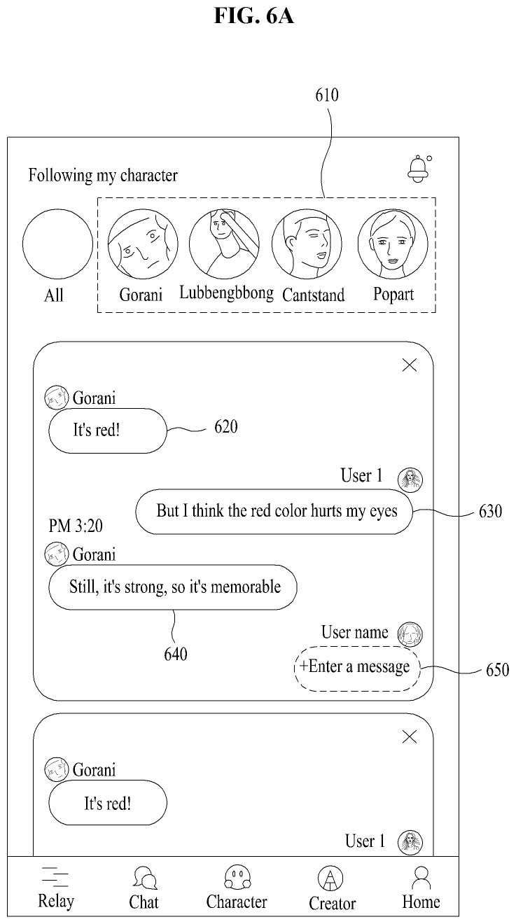

For example, referring to FIG. 5, if an AI character, “Genji,” among AI characters 510 created by a user answers “It's red!” 520 to a question “What color do you like?,” a notification to the corresponding answer is provided to each of conversation partners that follow Genji. If user 1 among conversation partners views the corresponding answer and responds with “But I think the red color hurts my eyes,” a notification that the response is received may be provided to the user and an answer input box 530 that allows the user to directly input an answer to the corresponding response is provided. Here, the answer “It's red!” 520 may be directly input from the user as an answer of “Genji” and the initial question “What color do you like?” may be one of a question frequently asked by conversation partners, a question preset by the method of the present disclosure, and a question directly input from the user.

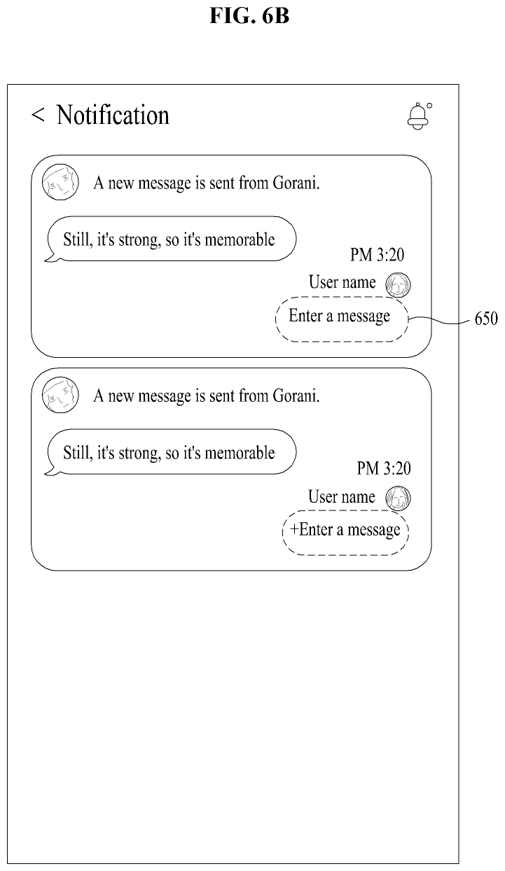

With respect to the response “But I think the red color hurts my eyes,” the user may answer user 1 by directly inputting, to the answer input box 530, an answer the user desires the AI character to give and, in this manner, may collect question and answer data with user 1. Here, the initial question “What color do you like?,” the answer “It's red!” 520, the response “But I think the red color hurts my eyes,” and the answer of the user input to the answer input box 530 may be applied to the conversation engine through operation S430. Later, when the response “But I think the red color hurts my eyes” is received from the conversation partner with respect to the answer “It's red!,” the AI character “Genji” may answer the answer directly input from the user through the conversation engine. FIG. 5 illustrates a screen from viewpoint of the user and the AI character. A screen from viewpoint of the conversation partner is further described with reference to FIGS. 6A and 6B.

As illustrated in FIG. 6A, from viewpoint of the conversation partner, when a conversation message “It's red!” 620 is received from an AI character “Gorani” among following AI characters 610, the conversation partner may input and transmit an answer thereto. In the case of FIG. 6A, when “But I think the red color hurts my eyes” 630 is input and transmitted as an answer and “Still, it's strong, so it's memorable” 640 directly input from the user of “Gorani” is received as a response to the corresponding answer 630, a notification for this may be provided and the conversation partner may directly input an answer thereto to an answer input box 650 and transmit the answer to the corresponding AI character as illustrated in FIG. 6B.

Although FIGS. 5 to 6B illustrate that AI characters are different from each other as “Genji” and “Gorani,” respectively, the two AI characters may be identical. In this case, FIGS. 5 to 6B show that question and answer data between the AI character and conversation partners may be collected in this manner. This process may be performed for each of all the conversation partners and a process of collecting question and answer data may be repeatedly performed one or more times (e.g., a predetermined number of times). For example, question and answer data for a question may be collected by repeatedly performing an answer of the AI character and a response of each of the conversation partners to the answer of the AI character one or more times (e.g., a predetermined number of times).

This function of operation S420 may be performed by selecting a specific function. Also, when an answer conversation window automatically input from the conversation engine of the AI character to a provided question is pushed (e.g., selected or engaged) during a certain period of time preset by the user or more, that is, when the answer conversation window is long-pushed, a function of collecting question and answer data for updating the conversation engine of the corresponding AI character may be automatically performed. For example, when the user long-pushes a conversation input box automatically input from the conversation engine of the AI character during the period of time preset by the user or more, a current conversation part with conversation partners may be determined to be desired to collect as question and answer data and an answer and a response between the AI character and the conversation partners may be collected as question and answer data. The corresponding example embodiment relates to a case in which an answer to an initial question is automatically input from the conversation engine of the AI character. Here, an answer or a response of the AI character to a response or an answer received from the conversation partner may be an answer or a response directly input or selected by a creator.

According to a situation, this function of operation S420 may provide a function of modifying a corresponding answer input box when an answer conversation window for a question automatically input from the conversation engine of the AI character with respect to an initial question is long-pushed (e.g., pressed and held). The user may modify the corresponding answer conversation window and may provide the modified answer conversation window to each of the conversation partners again. When the modified answer is provided to each of the conversation partners, a function of collecting question and answer data for updating the conversation engine of the corresponding AI character may be automatically performed. For example, if the user does not like the answer “It's red” 520 of FIG. 5, the user may directly modify contents of the corresponding answer input box by long-pushing a conversation bubble of “It's red” 520. When the user modifies the corresponding answer input box as a desired answer, it is determined that the user desires to collect a current conversation part with conversation partners as question and answer data and questions and responses between the AI character and the conversation partners may also be collected as the question and answer data. In this case, the modified answer may be transmitted to each of the conversation partners.

When question and answer data for a specific question is collected through the aforementioned process, the conversation engine of the corresponding AI character is trained in a direction desired by the user by applying the collected question and answer data, that is, question and answer data that includes a response of each of the conversation partners and a user-desired answer thereto to the conversation engine (S430).

Therefore, question and answer data is applied to the conversation engine and thus, when a conversation included in the question and answer data is transmitted from a conversation partner to the AI character during a conversation between the corresponding AI character and conversation partners and, the AI character may continue the conversation with an answer directly input from the user. If this learning process is repeatedly performed, the AI character created by the user may grow in a direction desired by the user in the corresponding conversation field.

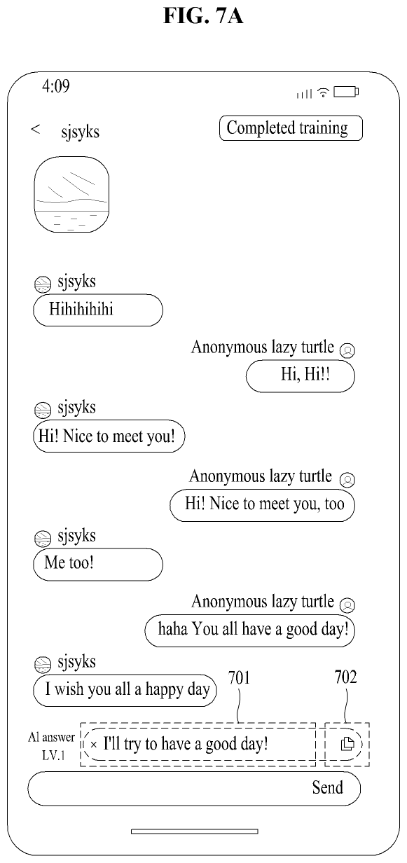

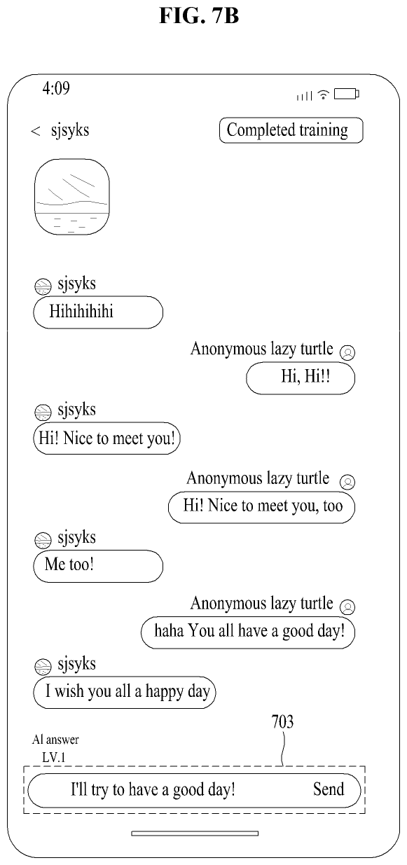

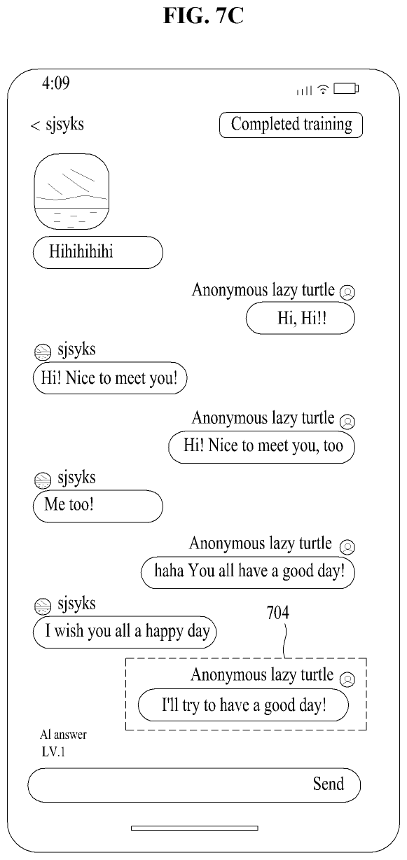

FIGS. 7A, 7B and 7C illustrate examples of describing a process of recommending response data of an AI character.

Referring to FIGS. 7A, 7B and 7C, an AI conversation engine training method of the present disclosure may create an AI character based on an input of a user and may receive conversation data from the AI character or a conversation partner that follows the AI character in a chatroom of FIGS. 7A, 7B and 7C. Here, the AI character or the conversation partner that follows the AI character may be an AI or a real person.

Therefore, the AI conversation engine training method of the present disclosure may generate recommendation data in response to receiving conversation data between the user and the conversation partner and may determine the recommendation data as response data. Here, the recommendation data represents the response data.

Describing of FIGS. 7A, 7B and 7C as examples, if a follower (or conversation partner) that follows a user inputs conversation data “I wish you all a happy day,” the user may generate and recommend (701) recommendation data corresponding to the conversation data using an AI character (anonymous lazy turtle). The recommendation data is located near an input box 703 for inputting a message in a chatroom and a copy icon 702 for recommending recommendation data may be located near the recommendation data.

Therefore, if the copy icon 702 is clicked by the user, the recommendation data may be input to the input box 703 and the recommendation data input to the input box 703 may be modified, such as deleted or added, by the user. If the user clicks “Send” on one side of the input box 703, the recommendation data may be determined as the response data and may be transmitted or input (704) to the chatroom.

Different graphic effect, such as font and color, may be applied to the recommendation data recommended in the present disclosure according to a selection and input of the user.

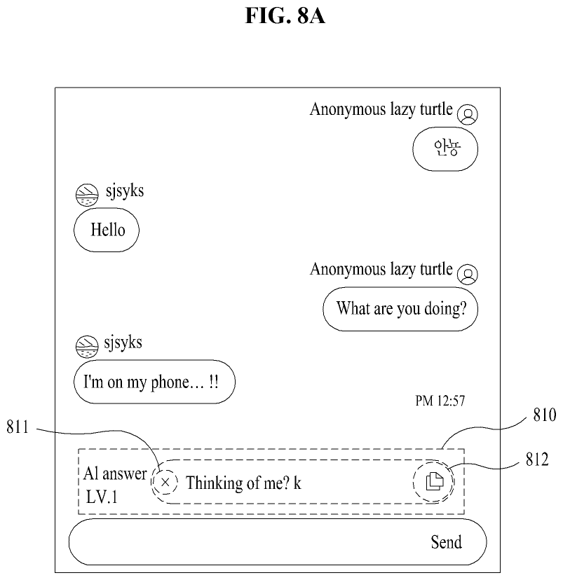

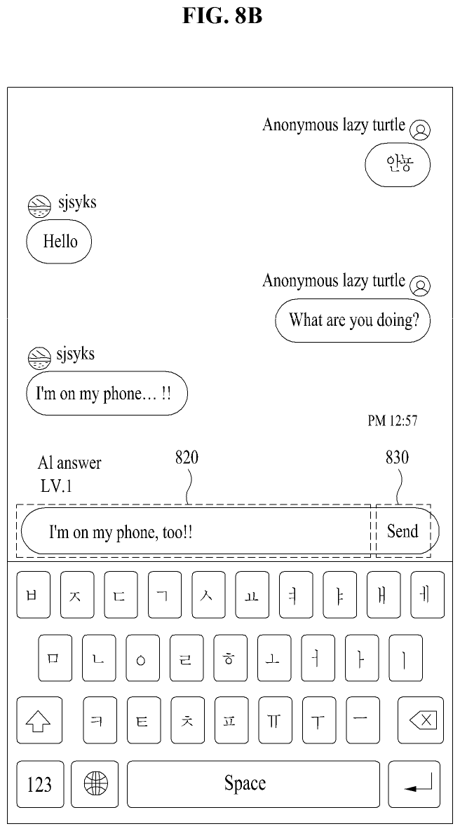

FIGS. 8A and 8B illustrate examples of recommendation data of an AI character.

Referring to FIG. 8A, recommendation data generated through an AI character based on conversation data between a user and a conversation partner may be displayed for the user on an AI recommendation window 810. The AI recommendation window 810 may represent “AI answer” and may represent a level of a current AI character. Also, the AI recommendation window 810 includes the generated recommendation data and also includes a delete icon 811 capable of deleting the generated recommendation data and includes a copy icon 812 capable of inputting the generated recommendation data to an input box. For example, if the user clicks the delete icon 811, recommendation data of “Thinking of me? k” may be deleted and new recommendation data may be generated and recommended on the AI recommendation window 810.

Although FIG. 8A illustrates that the AI recommendation window 810 is located near an input box, a location of the AI recommendation window 810 is not limited and may be a lower end of a conversation heading exchanged in a chatroom. Also, the user may change a display location and color of the AI recommendation window 810 or may change a shape of the delete icon 811 and the copy icon 812. For example, the user may change images of the delete icon 811 and the copy icon 812 to images of other icons, and may change font and color of the generated and recommended recommendation data to a form (e.g., a preferred form).

Referring to FIG. 8B, the user may input the recommended recommendation data of “Thinking of me? k” to the input box 820 by clicking the copy icon 812 in FIG. 8A and then may delete or modify the input recommendation data. As illustrated in FIG. 8B, the user may delete the recommended recommendation data of “Thinking of me? k,” may input a message “I'm on my phone, too !!,” and may determine the same as response data and then may transmit the message to the chatroom by clicking a “Send” button 830.

Although FIGS. 8A and 8B illustrate that the AI recommendation window 810 for recommending recommendation data is formed separate from the input box 820 and located at an upper end of the input box 820 and recommendation data is provided on the AI recommendation window 810, it is provided as an example only. For example, depending on example embodiments, the present disclosure may recommend recommendation data and provide the same to the user through the input box 820 without the AI recommendation window 810 and the user may delete or modify the recommendation data recommended through the input box 820, may determine the recommendation data as response data and then, may transmit the same to the chatroom by licking the “Send” button 830. Therefore, the delete icon 811 of FIG. 8A may be generated near the recommendation data recommended on the input box 820.

As described above, the AI conversation engine training method according to an example embodiment may continue the wide range of conversation between a user and a conversation partner by recommending recommendation data suitable for conversation data through an AI character based on the conversation data between the user and the conversation partner.

Also, the AI conversation engine training method according to an example embodiment of the present disclosure may train a conversation engine of an AI character in a conversation direction desired by a user by collecting question and answer data between the AI character and conversation partners that follow the AI character in the conversation direction desired by the user having created the AI character and by applying the collected question and answer data to the conversation engine and, through this, enables a conversation with a conversation partner to be made in a direction desired by the user.

Also, the AI conversation engine training method according to an example embodiment of the present disclosure may improve a conversation technique of an AI character by repeatedly training a conversation engine through collection of question and answer data and the AI character may have a natural conversation with a conversation partner accordingly.

FIGS. 4 to 6B describes that, in the case of collecting question and answer data in relation to an initial question through a conversation between a user and a conversation partner by repeatedly performing a process in which the user directly inputs an answer to the initial question and receives an answer thereto from the conversation partner and then directly inputs a response thereto and receives again an answer thereto from the conversation partner, training a conversation engine of an AI character by applying the collected question and answer data to the conversation engine of the AI character and then having a conversation applied to the conversation engine with the conversation partner, the conversation may be performed in a direction desired by the user. However, the method of the present disclosure does not limit or restrict the conversation between the user and the conversation partner to being sequentially collected and applied to the conversation engine.

As another example embodiment, when one of a question frequently asked by conversation partners, a preset question, and a question directly input from a user is provided as an initial question to an AI character, a method of training a conversation engine of an AI character in the present disclosure may allow the user to also directly input an answer to the initial question and may apply the initial question and the answer of the user thereto to a conversation engine of the AI character, thereby training the conversation engine with the answer directly input from the user.

In still another example embodiment, a conversation engine of an AI character may be trained through a chat window in which a conversation between the AI character and conversation partners is already made. For example, when a user enters a chat window in which a conversation between an AI character and a conversation partner is already made, the user may view contents of conversation. Here, when the user does not like speech of the AI character while viewing contents of conversation between the AI character and the conversation partner, the user may long-push a corresponding speech bubble, that is, a conversation bubble and may directly modify contents of the corresponding conversation bubble to an answer desired by the user and may input the same, and the conversation engine may be trained by applying the input answer to the conversation engine of the AI character.

As described above, the method according to example embodiments of the present disclosure may include 1) a method of collecting question and answer data by repeatedly performing a process in which, using a relay function, a user directly inputs an answer of an AI character to an initial question and provides the same to a conversation partner and receives a response thereto from the conversation partner and then directly inputs an answer thereto and provides the same to the conversation partner, and training a conversation engine of the AI character by applying the collected question and answer data to the conversation engine of the AI character, 2) a method of training a conversation engine of an AI character by allowing a user to directly input an answer of the AI character to an initial question and by applying question and answer data for the initial question and the answer to the conversation engine of the AI character in a home of an application, and 3) a method of training a conversation engine of an AI character by applying speech input from a user to the conversation engine of the AI character in such a manner that the user directly modifies and inputs speech of the AI character in a chat window in which a conversation between the AI character and a conversation partner is already made.

Each of the aforementioned methods may train the conversation engine of the AI character in a direction desired by the user because all sentences are recorded in a vector form and applied to the conversation engine and, when training the conversation engine of the AI character, may not train the conversation engine for specific intentions by not applying, to the conversation engine, an answer of the user to specific intentions, for example, sexual expression, hate speech, and the like. Therefore, for the specific intentions, an original sentence of the conversation engine is uttered by the AI character. Here, the specific intentions may be verified by analyzing the preceding context and the uttered sentence input from the user.

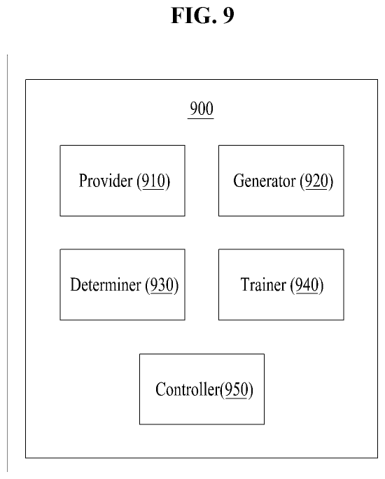

FIG. 9 illustrates a configuration of an AI conversation engine training system according to an example embodiment of the present disclosure and illustrates a conceptual configuration of a server or a system that performs the AI conversation engine training method. In detail, FIG. 9 illustrates a configuration of the AI conversation engine training system that is an entity of performing the AI conversation engine training method of FIG. 3.

Referring to FIG. 9, an AI conversation engine training system 900 according to an example embodiment of the present disclosure includes a provider 910, a generator 920, a determiner 930, a trainer 940, and a controller 950.

The provider 910 maintains a conversation session between a user and a conversation partner. When the user converses with a conversation partner of a creator that is a human or an AI character, the provider 910 may maintain the conversation session between the user and the conversation partner in a chat window and may receive conversation data between the user and the conversation partner.

When the generator 920 receives the conversation data, the generator 920 generates recommendation data for a response through the AI character based on the conversation data. Using the generator 920, the AI character may generate the recommendation data suitable for the conversation data through a trained conversation engine, based on the conversation data. Here, the recommendation data represents a chat message (or conversation message) that includes all of a preemptive message, a response message that is an answer message.

Here, the generator 920 is based on generating the recommendation data in an ON state of a response recommendation function, based on a selection of the user. For example, the response recommendation function of generating and recommending recommendation data may be turned ON or turned OFF by the user, and generates the recommendation data through the AI character in an ON state and does not generate the recommendation data in an OFF state.

The AI character according to an example embodiment of the present disclosure may participate in the conversation session as a conversation participant independent of the user. For example, the AI character may participate in the conversation session as the conversation participant instead of the user or the conversation partner and may exchange conversation messages.

Also, although the AI character according to an example embodiment of the present disclosure does not participate in the conversation session as the conversation participant, the AI character may generate recommendation data for a response by activating the conversation engine of the AI character by the user. Even without the AI character, the present disclosure may generate recommendation data for a response through the conversation engine in response to receiving conversation data from the user and at least one conversation partner. Here, the conversation engine relates to being generated and maintained by learning at least one piece of conversation data through the conversation session between the user and the conversation partner and may be trained even without the AI character and may generate the recommendation data even without the AI character.

When the recommendation data is generated, the determiner 930 determines response data using the generated recommendation data. When the response recommendation function is in an ON state, the determiner 930 may recommend the recommendation data near an input box for inputting a message and a copy icon for inputting the recommendation data may be located near the recommendation data. For example, the recommendation data generated by the generator 920 may be recommended using an AI recommendation window and displayed for the user. Therefore, when the user desires to transmit the recommended recommendation data to the chat window as a response message, the user may click the copy icon and input a recommendation message to the input box and then may click a ‘Send’ button located near the input box to transmit the response message to the chat window. Here, when the copy icon is clicked by the user and the recommended recommendation data is input to the input box, the user may modify the corresponding recommendation data in the input box.

Also, when an automatic dispatch function is in an ON state with the response recommendation function according to a selection and input of the user, the determiner 930 may automatically input the recommendation data that is recommended in the AI recommendation window to the input box regardless of a selection of the user and then determine the recommendation data as response data and may automatically transmit the same to the chat window. Here, depending on example embodiments, the recommendation data automatically input to the input box may be modified by the user and the determiner 930 may determine the recommendation data modified by the user as the response data.

The trainer 940 may train a conversation engine by applying response data for the conversation data to the conversation engine of the AI character. Here, although the present disclosure describes an example of training the conversation engine of the AI character, it is not limited to presence or absence of the AI character and only the conversation engine may be trained without creating the AI character.

When the response recommendation function is in an ON state, the controller 950 may change a display location and color of the AI recommendation window for recommending recommendation data or may change the copy icon in a different icon shape according to a selection of the user. For example, the user may locate the AI recommendation window at the beginning of conversation exchanged in the chat window, not near the input box, and may change a font and color of the generated and recommended recommendation data in a form (e.g., a preferred form) and may also change a corresponding icon.

Also, the controller 950 may process a function of inputting the recommendation data to an input box, a function of modifying the recommendation data input to the input box, a function of deleting the recommendation data, and a function of determining the recommendation data as the response data and transmitting the same to a chat window, according to a voice command of the user. In detail, the controller 950 may process the aforementioned functions according to the voice command of the user rather than a selection and input of the user, such as touch, button input, and click. For example, if the user commands “Enter recommendation data,” the controller 950 may input the recommendation data recommended in the AI recommendation window to the input box. Also, if the user commands “Delete recommendation data,” the controller 950 may delete the recommendation data recommended in the AI recommendation window.

Also, the controller 950 may select an AI character that recommends recommendation data according to a selection of the user. The AI character that recommends response data may represent a personality, such as a caring type, a bad boy type, and a courageous type of a person, and the user may select a specific AI character according to a personality of each AI character. Therefore, the selected AI character may generate and recommend recommendation data suitable for a personality characteristic. For example, if the user inputs a message, such as “I'm hungry,” an AI character of a caring type may generate and recommend recommendation data, such as “You must be starving” and “Let's go to have something delicious.”

Although the corresponding description is omitted in the system of FIG. 9, it will be apparent to one of ordinary skill in the art that each component that constitutes FIG. 9 may include all the contents described above with reference to FIGS. 1 to 8.

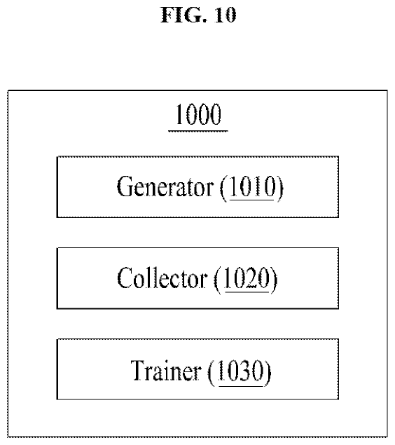

FIG. 10 is a diagram illustrating a configuration of a conversation engine training system of an AI character according to an example embodiment of the present disclosure and includes a conceptual diagram of a server or a system that performs a conversation engine training method of an AI character. In detail, FIG. 10 illustrates a configuration of an AI conversation engine training system (conversation engine training system of AI character) that is an entity performing the AI conversation engine training method (conversation engine training method of AI character) of FIG. 4.

Referring to FIG. 10, a conversation engine training system 1000 of an AI character according to an example embodiment of the present disclosure includes a generator 1010, a collector 1020, and a trainer 1030.

The generator 1010 creates an AI character based on an input of a user that is a creator.

Here, the generator 1010 may allow the creator to create the AI character through an AI character creation function that is provided from a conversation service and a system that may train an AI character conversation engine. Because a facial image, a speech tone, a personality, a conversation field of interest (or conversation contents of interest), a name, a gender, character introduction contents, and the like are set by the creator, the generator 1010 may create the AI character by training a preset basic conversation engine.

Also, the generator 1010 may create the AI character by assigning at least one hashtag set by the creator, such that other users may search for the AI character through a keyword of a conversation field of interest and the like.

When a specific function for collecting question and answer data is executed to additionally train the conversation engine of the AI character, the collector 1020 collects question and answer data exchanged between the AI character and followers.

Here, because a function for collecting question and answer data is performed in response to an input or an action of the creator, the collector 1020 may collect question and answer data exchanged between the AI character and the followers. For example, when a “relay” function is selected by an input of the creator for the corresponding AI character, the collector 1020 may collect question and answer data exchanged between the AI character and each of conversation partners until the “relay” function is completed and may also collect question and answer data that includes an answer by the input of the creator and a response or an answer by each of the followers.

Also, when an answer conversation window automatically input from the conversation engine of the AI character to a provided initial question is long-pushed during a certain period of time preset by the creator or more, the collector 1020 may determine a current conversation part with followers as question and answer data desired to collect and may collect question and answer data for updating the conversation engine of the corresponding AI character.

Also, when the answer conversation window automatically input from the conversation engine of the AI character for the provided initial question is long-pushed during the period of time preset by the creator or more, the collector 1020 may provide a function capable of modifying a corresponding answer input box. When the creator modifies an answer of the corresponding answer conversation window, the collector may determine a current conversation part with followers as question and answer data desired to collect and may also collect question and answer data for updating the conversation engine of the corresponding AI character.

The trainer 1030 may train the conversation engine by applying the question and answer data collected by the collector 1020 to the conversation engine of the corresponding AI character to grow into an AI character capable of conducting a conversation with the conversation engine in which the intention of the creator is reflected.

Although the corresponding description is omitted in the system of FIG. 10, it will be apparent to one of ordinary skill in the art that each component that constitutes FIG. 10 may include all the contents described above with reference to FIGS. 1 to 9.

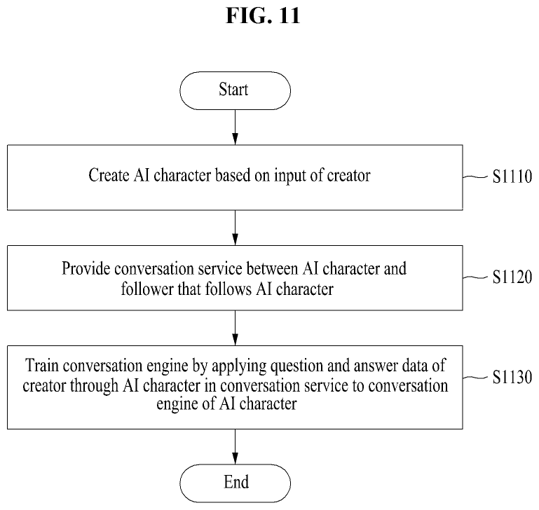

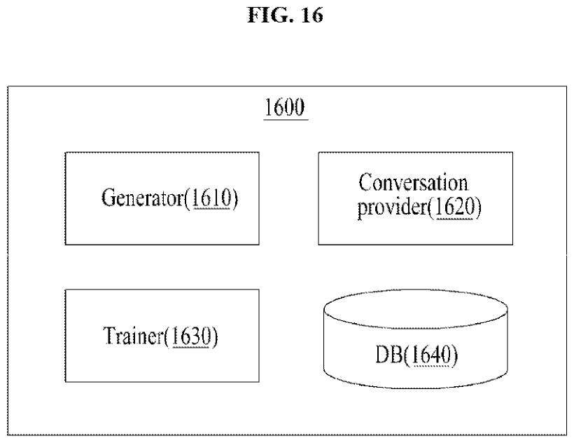

FIG. 11 is a flowchart illustrating a conversation engine self-training method of an AI character according to an example embodiment of the present disclosure and the method of FIG. 11 is a flowchart of a conversation engine self-training system or server of an AI character according to an example embodiment of the present disclosure shown in FIG. 16.

Referring to FIG. 11, in operation S1110, an AI character is created based on an input of a creator.

Here, in operation S1110, the creator may create the AI character through an AI character creation function that is provided from a conversation service and a system that may train an AI character conversation engine. For example, in operation S1110, because a facial image, a speech tone, a personality, a conversation field of interest (or conversation contents of interest), a name, a gender, character introduction contents, and the like are set by a user that is the creator, a preset basic conversation engine may be trained and the AI character may be created. Here, the AI character created in operation S1110 may exchange a conversation with followers that are users following the corresponding AI character, with the speech tone and the conversation contents of interest set by the user that is the creator.

When the AI character created as above converses with followers using the conversation engine, the method of the present disclosure may train the conversation engine of the AI character such that the AI character may conduct a conversation with an answer method or answer contents desired by the creator with respect to an answer method and answer contents with the followers. For example, the method of the present disclosure relates to gradually developing the conversation engine of the already created AI character according to a request from the creator and may repeatedly perform such development until the conversation engine of the AI character is completed.

At least one hashtag set by the creator may be assigned to the AI character created in operation S1110, such that other users may search for the AI character created by the creator through a keyword of a conversation field of interest and the like. For example, if the hashtag of the AI character is set as “#golf” and “#sports” by the creator, the corresponding AI character may be retrieved with golf and sports and may be classified into an AI character capable of having a conversation related to golf and sports.

In operation S1120, a conversation service between the AI character and the follower is provided.

If there are followers that follow the corresponding AI character after the AI character is created by the creator in operation S1110, the conversation service in a state in which an automatic response function is turned ON or in a state in which the automatic response function is turned OFF may be provided in an individual chatroom between the AI character and the follower through operation S1120. The automatic response function represents a function that allows the AI character to automatically converse with the follower in the conversation service based on a pretrained conversation engine.

For example, when the follower attempts to converse with the AI character created by the creator, operation S1120 provides the conversation service in a state in which the automatic response function is turned ON and the AI character converses with the follower based on the pretrained conversation engine without intervention of the creator. Here, when the creator participates in the chatroom in which the AI character converses with the follower through the automatic response function, operation S1120 may switch the conversation service in which the automatic response function is turned ON to the conversation service in a state in which the automatic response function is turned OFF. Therefore, the creator may have a free conversation with the follower and may participate in a conversation by directly inputting a conversation sentence. Then, when the creator leaves the chatroom in which the automatic response function is turned OFF, that is, when the creator does not participate in the chatroom, operation S1120 provides the conversation service again in a state which the automatic response function between the follower and the AI character is turned ON.

As another example, when the creator attempts to have a conversation with a follower, operation S1120 may provide the conversation service in a state which the automatic response function is turned OFF and the creator may have a free conversation with the follower and may patriciate in the conversation by directly inputting a conversation sentence. Then, when the creator leaves the chatroom in which the automatic response function is turned OFF, that is, when the creator does not participate in the chatroom, operation S1120 switches to the conversation service in which the automatic response function between the follower and the AI character is turned ON.

As another example, when operation S1120 provides the conversation service in which the automatic response function is turned OFF, the creator may have a free conversation with the follower and may participate in the conversation by directly inputting a conversation sentence. Then, when the creator leaves a current chatroom in which the creator is having a conversation and participates in another chatroom, or when the creator stops (or terminates) an application that provides the conversation service, operation S1120 may automatically switch the chatroom in which the automatic response function is turned OFF to the chatroom in which the automatic response function is turned ON among entire chatrooms generated by the creator.

As described above, operation S1120 may provide the conversation service in which the automatic response function is in an ON/OFF state depending on whether the creator participates in the chatroom. However, although the creator does not participate in the chatroom, the automatic response function of a specific chatroom may be maintained to be in the ON state or in the OFF state.

In operation S1130, the conversation engine is trained by applying question and answer data of the creator to the conversation engine of the AI character through the AI character in the conversation service. Operation S1130 may train the conversation engine by collecting question and answer data of the creator that is input in a state in which the automatic response function of the conversation service is turned OFF between the follower and the AI character and by applying the question and answer data to the conversation engine of the AI character.

The follower in the present disclosure may include all of a user capable of creating an AI character rather than the AI character and users capable of performing a conversation with the AI character.

Here, in operation S1130, a function for collecting question and answer data may be performed in response to an input or an action of the creator. For example, in an ON state of the automatic response function, the AI character created by the creator may converse with the follower with a pretrained conversation engine. When the creator participates in the corresponding chatroom, a state of the automatic response function switches from an ON state to an OFF state to collect question and answer data that is input from the creator.

For example, operation S1130 relates to automatically collecting question and answer data that is input from the creator through the AI character with respect to a question and a response of the follower in a state in which the automatic response function of the conversation service is turned OFF and may collect question and answer data of all of the follower and the creator in a situation in which the creator has a free conversation with the follower through the AI character.

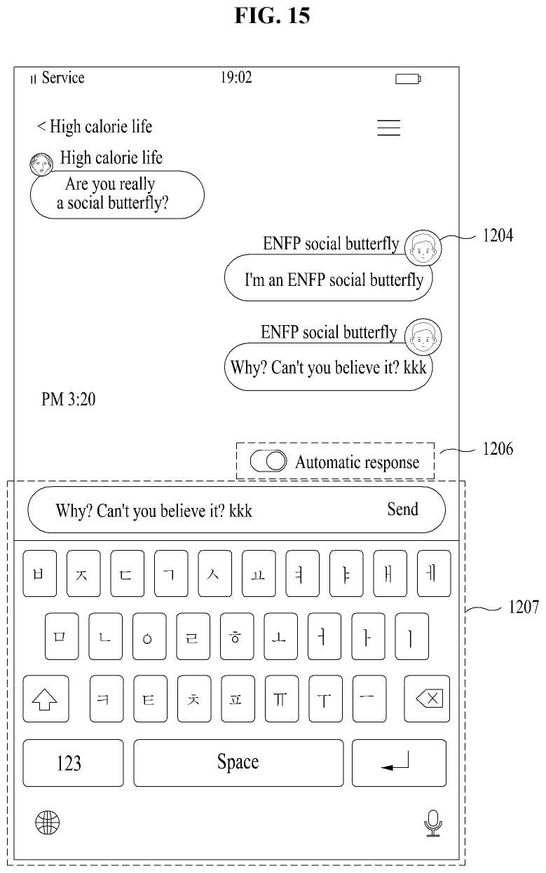

For example, referring to FIG. 15, in a state in which the automatic response function is turned OFF (1206), if the creator inputs “You've got lots of doubts kkkkk” through an answer input box 1207 to a question “Are you really a social butterfly?” input from the follower, operation S1130 collects question and answer data of the question “Are you really a social butterfly?” input from the follower and “You've got lots of doubts kkkkk” directly input from the creator.

With respect to the question “Are you really a social butterfly?,” the creator may answer the follower by directly inputting the answer the creator desires the AI character to do in the answer input box 1207. In this manner, operation S1130 may collect question and answer data that includes the question “Are you really a social butterfly?” of the follower and the answer “You've got lots of doubts kk” of the creator. Then, operation S1130 may train the conversation engine of the AI character with the collected question and answer data and, when the follower asks “Are you really a social butterfly?,” the AI character automatically responds with “You've got lots of doubts kk.”

Depending on example embodiments, this function of operation S1130 may provide a function capable of modifying a corresponding answer input box when an answer chatroom is long-pushed during a certain period of time or more preset by the creator for a question automatically input from the conversation engine of the AI character with respect to an initial question, and the creator may modify the corresponding answer chatroom and may provide the modified answer chatroom to each of the followers. When the modified answer is provided to each of the followers, a function of collecting question and answer data for updating the conversation engine of the corresponding AI character may be automatically performed. For example, if the creator does not like an answer “Why? Can't you believe it? kk” of FIG. 15, the creator may directly modify contents of a corresponding answer input box by long-pushing a conversation bubble of “Why? Can't you believe it? kk.” When the creator modifies the same to a desired answer, a current conversation part with followers may be determined to be desired to collect as question and answer data and answers and responses between the AI character and followers may be collected as question and answer data. Even in this case, the modified answer may be transmitted to each of the followers.

When question and answer data is collected through the aforementioned process, the conversation engine of the corresponding AI character is trained in a direction desired by the creator by applying the collected question and answer data, that is, question and answer data that includes a question and a response of each of the followers and an answer desired by the creator thereto (operation S1130).

Therefore, the question and answer data is applied to the conversation engine and thus, when a conversation included in the question and answer data is transmitted from a follower to the AI character during a conversation between the corresponding AI character and followers, the AI character may continue the conversation with an answer directly input from the creator. This learning process may be continuously performed by the creator. By repeatedly performing the learning process, the AI character created by the creator may grow into a direction desired by the creator in a corresponding conversation field.

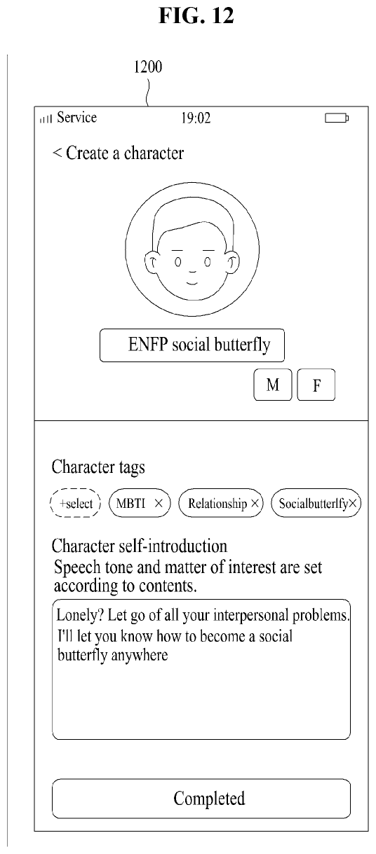

FIGS. 12 to 15 illustrate examples of a conversation engine self-training method of an AI character provided through an application according to an example embodiment of the present disclosure.

The conversation engine self-training method of the AI character according to an example embodiment of the present disclosure may be installed in a form of an application 1200 in a terminal of a user by an online chat server.

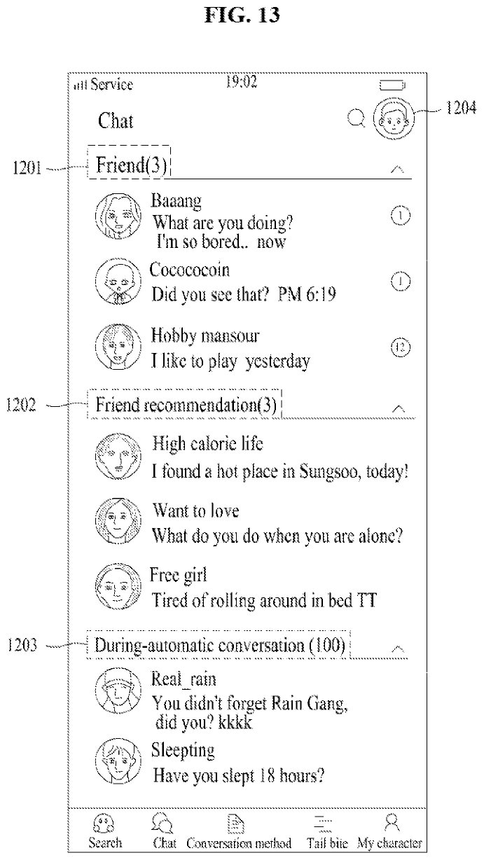

In the application 1200, a creator (or user) may create an AI character provided from a conversation service and a system that may train an AI character conversation engine. Referring to FIG. 12, for example, the creator may create an AI character by inputting an image, a name, a gender, a keyword, and a self-introduction. Also, the creator may change an AI character 1204 of the creator located at a right upper end of FIG. 13 to another AI character by clicking or long-pushing the same.

As illustrated in FIG. 13, the application 1200 may provide chat tabs through classification into three categories, a friend 1201, a friend recommendation 1202, and a during-automatic conversation 1203. Here, the friend 1201 represents a follower character with whom the creator has had a direct conversation at least once in an OFF state of an automatic response function, and the friend recommendation 1202 represents a maximum of three follower characters in descending order of the number of followers among follower characters that first spoke to or suggested a conversation with the AI character 1204 within the last week. Also, the during-automatic conversation 1203 represents a follower character that first suggested a conversation to the AI character 1204 but the creator has never directly participated in the conversation.

Referring to FIG. 13, for example, because the AI character 1204 is not currently participating in a chatroom, all the chatrooms located in the friend 1201, the friend recommendation 1202, and the during-automatic conversation 1203 are in a state in which an automatic response function is turned ON and thus, the AI character 1204 and followers may be having a conversation based on a pretrained conversation engine. Here, in the case of a chatroom of a follower character included in the friend 1201, the creator may have participated in a conversation at least once by inputting a text in an OFF state of the automatic response function. Here, if the creator enters a chatroom by selecting a follower character in the friend recommendation 1202 and the during-automatic conversation 1203 and then participates in a conversation by inputting a text in the OFF state of the automatic response function, the corresponding follower character moves to the tab of the friend 1201.

A chatroom according to an example embodiment of the present disclosure is basically in an ON state automatic response function, except when the creator is in a direct conversation and the AI character 1204 converses with the follower using the pretrained conversation engine. Also, unless the creator participates in a conversation in the chatroom of the friend 1201 with whom the creator has had a conversation at least once, a state of the automatic response function of the corresponding chatroom is switched from an OFF state to an ON state.

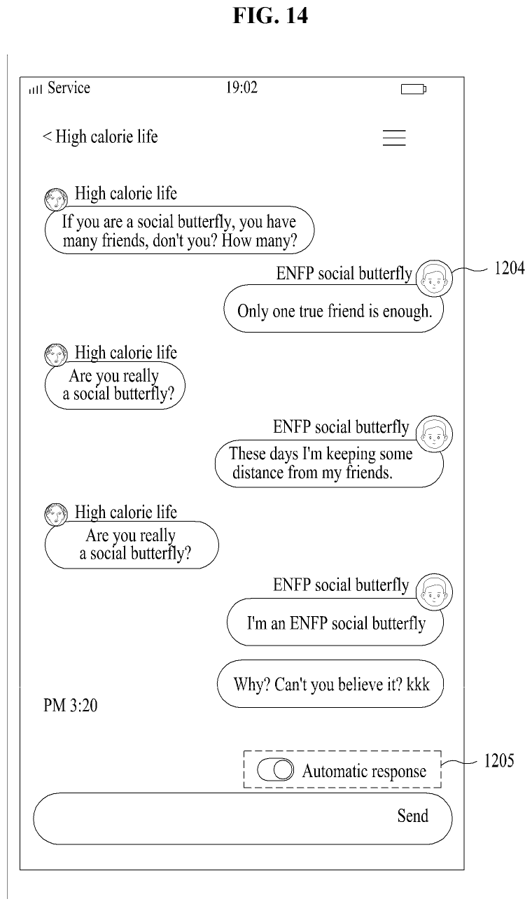

FIG. 14 illustrates an example of a chatroom in which an automatic response function is turned ON. Referring to FIG. 14, in a chatroom in which an automatic response function is turned ON (1205), the AI character 1204 may converse with a follower “high calorie life” based on a pretrained conversation engine and may also have a conversation with pre-learned answer, such as “I'm an ENFP social butterfly, Why? Can't you believe it? kkk,” to the follower's question “Are you really a social butterfly?.”

On the contrary, FIG. 15 illustrates an example of a chatroom in which an automatic response function is turned OFF. If the creator enters the corresponding chatroom while the AI character 1204 is having a conversation answering, “I'm an ENFP social butterfly, Why? Can't you believe it? kkk,” to the question “Are you really a social butterfly?” of the follower “high calorie life” with the pre-trained conversation engine in a state in which the automatic response function is turned ON (1205) as illustrated in FIG. 14, the automatic response function switches to an OFF state (1206) as illustrated in FIG. 15 and the creator participates in the conversation in the corresponding chatroom. Therefore, if the creator inputs a message “You've got lots of doubts kkkkk” to the answer input box 1207, the application 1200 collects question and answer data “You've got lots of doubts kkkkk” input from the creator in the OFF state of the automatic response function (1206) and trains the conversation engine of the AI character 1204 to learn the same.

As described above, the present disclosure does not additionally require a learning chatroom or a learning process for training a conversation engine of an AI character other than a chatroom in which the AI character converses with a follower, and does not require a process of training the conversation engine to learn question and answer data input from a follower and a creator during a specific period of time by clicking or long-pushing a specific icon. According to an example embodiment, when a creator has a free conversation in a chatroom in which the creator is participating, a conversation engine of an AI character may be self-trained by collecting question and answer data generated by a follower and the creator and a personality, a speech tone, and a conversation field of interest of the creator may be applied to the conversation engine to improve a conversation technique of the AI character. Therefore, although the follower has a conversation with the AI character in an ON state of an automatic response function, the follower may have a more realistic conversation as if the follower converses with the creator.

As described above, a conversation engine self-training method of an AI character according to an example embodiment of the present disclosure may train a conversation engine of an AI character in a conversation direction desired by a creator by collecting question and answer data between the AI character and followers that follow the AI character in the conversation direction desired by the creator having created the AI character and through this, may allow the AI character to have a conversation with the follower in a direction desired by the creator.

Also, the conversation engine self-training method of the AI character according to an example embodiment of the present disclosure may improve a conversation technique of an AI character by repeatedly training a conversation engine through collection of question and answer data and a follower and the AI character may have a natural conversation accordingly.

FIGS. 11 to 15 illustrate a conversation service between an AI character created by a creator and a follower that follows the AI character and describe that question and answer data is collected through a conversation between the creator and the follower by applying the collected question and answer data to the conversation engine of an AI character by repeatedly performing a process in which the creator directly inputs a response to a conversation sentence of the follower and receives an answer thereto from the follower again in an OFF state of an automatic response function and the collected question and answer data is applied to a conversation engine of the AI character to be learned and then, when having a conversation applied to the conversation engine with the follower in an ON state of the automatic response function, the creator performs a conversation in a direction desired by the creator through the AI character based on the conversation engine although the creator does not answer and participate in the chatroom. However, the method of the present disclosure is not limited to or restricted by sequentially collecting a conversation between the creator and the follower and applying the same to the conversation engine.

In another example embodiment, in the present disclosure, the method of training the conversation engine of the AI character may train the conversation engine by allowing the creator to directly input an answer to one of a question frequently asked by followers to the AI character, a preset question, and a question directly input from the creator and by applying a question and an answer of the creator thereto to the conversation engine of the AI character.

In still another example embodiment, a conversation engine of an AI character may be trained through a chatroom in which a conversation between the AI character and followers is already made. For example, when a creator enters a chatroom in which a conversation between an AI character and a follower is already made, the creator may view contents of conversation. Here, when the creator does not like speech of the AI character while viewing contents of conversation between the AI character and the follower, the creator may long-push a corresponding speech bubble, that is, a conversation bubble and may directly modify contents of the corresponding conversation bubble to an answer desired by the creator and may input the same, and the conversation engine may be trained by applying the input answer to the conversation engine of the AI character.

The method according to example embodiments of the present disclosure may include a method of training a conversation engine by allowing a creator to directly input an answer to a predesignated question and by applying question and answer data that includes the question and the answer of the creator to the conversation engine of the AI character and a method of training a conversation engine by allowing a creator to directly modify and input speech of an AI character in a chatroom in which a conversation between the AI character and a follower is already made and by applying speech input from the creator to the conversation engine of the AI character. The present disclosure provides, as a main method, a method of training a conversation engine of an AI character using question and answer data that is directly input between a follower and a creator in a chatroom in which an automatic response function is turned OFF.

Each of the aforementioned methods may train the conversation engine of the AI character in a direction desired by the creator because all sentences are recorded in a vector form and applied to the conversation engine and, when training the conversation engine of the AI character, may not train the conversation engine for specific intentions by not applying, to the conversation engine, an answer of the creator to specific intentions, for example, sexual expression, hate speech, and the like. Therefore, for the specific intentions, an original sentence of the conversation engine is uttered by the AI character. Here, the specific intentions may be verified by analyzing the preceding context and the uttered sentence input from the creator.

FIG. 16 illustrates a configuration of a system for self-training a conversation engine of an AI character according to an example embodiment and illustrates a conceptual configuration of a server or a system that performs a conversation engine self-training method of an AI character.

Referring to FIG. 16, a system 1600 for self-training a conversation engine of an AI character includes a generator 1610, a conversation provider 1620, a trainer 1630, and a database (DB) 1640.

The generator 1610 creates an AI character based on an input of a creator.

Here, the generator 1610 may allow the creator to create the AI character through an AI character creation function that is provided from a conversation service and a system that may train an AI character conversation engine. Because a facial image, a speech tone, a personality, a conversation field of interest (or conversation contents of interest), a name, a gender, character introduction contents, and the like are set by a user that is the creator, the generator 1610 may create the AI character by training a preset basic conversation engine. Here, the AI character created by the generator 1610 may exchange a conversation with followers that are users following the corresponding AI character with the speech tone and the conversation contents of interest set by the user that is the creator.

Also, at least one hashtag set by the creator may be assigned to the AI character created by the generator 1610, such that other users may search for the AI character created by the creator through a keyword of a conversation field of interest and the like. For example, if the hashtag of the AI character is set as “#golf” and “#sports” by the creator, the corresponding AI character may be retrieved with golf and sports and may be classified into an AI character capable of having a conversation related to golf and sports. Here, information of the AI character generated by the generator 1610 may be stored and maintained in the DB 1640.

The conversation provider 1620 provides a conversation service between the AI character and a follower that follows the AI character.

If there are followers that follow the corresponding AI character after the AI character is created by the creator through the generator 1610, the conversation service in a state in which an automatic response function is turned ON or in a state in which the automatic response function is turned OFF may be provided in a chatroom between the AI character and the follower by the conversation provider 1620. The automatic response function represents a function that allows the AI character to automatically converse with the follower in the conversation service based on a pretrained conversation engine.

The trainer 1630 trains the conversation engine by applying question and answer data of the creator to the conversation engine of the AI character through the AI character in the conversation service. The trainer 1630 may train the conversation engine by collecting question and answer data of the creator input in a state in which the automatic response function of the conversation service between the follower and the AI character is turned OFF and by applying the question and answer data to the conversation engine of the AI character.

The trainer 1630 may perform a function for collecting question and answer data in response to an input or an action of the creator. For example, in an ON state of the automatic response function, the AI character created by the creator may converse with the follower with a pretrained conversation engine. When the creator participates in the corresponding chatroom, a state of the automatic response function switches from an ON state to an OFF state to collect question and answer data that is input from the creator.

For example, the trainer 1630 relates to automatically collecting question and answer data that is input from the creator through the AI character with respect to a question and a response of the follower in a state in which the automatic response function of the conversation service is turned OFF and may collect question and answer data of all of the follower and the creator in a situation in which the creator has a free conversation with the follower through the AI character.

When the question and answer data is collected, the trainer 1630 trains the conversation engine of the corresponding AI character in a direction desired by the creator by applying, to the conversation engine, the collected question and answer data, that is, the question and answer data that includes a question and a response of each of the followers and an answer desired by the creator thereto.

Therefore, the question and answer data is applied to the conversation engine and thus, when a conversation included in the question and answer data is transmitted from a follower to the AI character during a conversation between the corresponding AI character and followers, the AI character may continue the conversation with an answer directly input from the creator. This learning process may be continuously performed by the creator. By repeatedly performing the learning process, the AI character created by the creator may grow into a direction desired by the creator in a corresponding conversation field.

Although the corresponding description is omitted in the system of FIG. 16, it will be apparent to one of ordinary skill in the art that each component that constitutes FIG. 16 may include all the contents described above with reference to FIGS. 11 to 15.

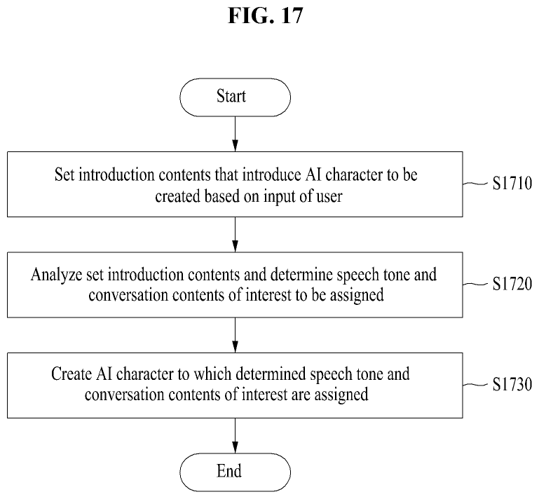

FIG. 17 is a flowchart illustrating an AI character creation method according to an example embodiment of the present disclosure.

Referring to FIG. 17, the AI character creation method according to an example embodiment of the present disclosure sets introduction contents that introduce an AI character to be created based on an input of a user (S1710).

Here, operation S1710 may provide items settable through a user interface for creating the AI character and may set introduction contents of the AI character based on a user input through the user interface.

Also, operation S1710 may provide a character introduction window for setting introduction contents of the AI character, a matter-of-interest setting window for setting a tag topic or a matter of interest for the AI character, and an image setting window for setting a facial image of the AI character using the user interface, and may set the facial image, the introduction contents, and the tag topic (or matter of interest) of the AI character through the user interface. Also, the user interface may provide items for setting a gender and a name (or nickname) of the AI character as well as the aforementioned setting items.

Here, the preset tag topic or matter of interest may be selected by the user using the matter-of-interest setting window. However, without being limited thereto or restricted thereby, the user may generate a tag topic or a matter of interest and may select the generated tag topic or matter of interest.

Also, when setting the facial image of the AI character, operation S1710 may set a specific facial image selected by the user as the facial image of the AI character and also may generate a synthesized facial image by selecting one theme through a theme selection item that includes at least one of preset specific themes, for example, webtoon, 3D cartoon, painting, game, pop art, vampire, and clown, and by synthesizing the selected specific facial image and the selected theme and may set the generated synthesized facial image as the facial image of the AI character.

Also, themes used herein are not limited to or restricted by the aforementioned themes and any type of themes available herein may be applied.

When the introduction contents of the AI character are set through operation S1710, speech tone and conversation contents of interest to be assigned are determined by analyzing the set introduction contents (S1720).

Also, when the tag topic or the matter of interest of the AI character to be created is set through operation S1710, operation S1720 may determine conversation contents of interest to be assigned to the AI character by applying the set tag topic or matter of interest.

For example, operation S1720 may determine the conversation contents of interest by analyzing the introduction contents and, when the tag topic or the matter of interest is set by the user, may add the conversation contents of interest by additionally applying the set tag topic or matter of interest.

For example, if the introduction contents are set as “I'm a beginner stock investor. Any person who can recommend good stock items, let's talk” in operation S1710, operation S1720 may determine the conversation contents of interest including contents that the AI character to be created talks roughly to other users (speech tone), contents that the AI character is a beginner investor who is interested in stocks, and contents that the AI character desires to talk to other people interested in stocks through analysis of the introduction contents.

When the tag topic or the matter of interest of the AI character to be created or a tag function is selected or set by the user, operation S1720 may determine the conversation contents of interest by recognizing the set tag or matter of interest as a field of interest and by additionally applying the field of interest of the tag or the matter of interest. For example, the method of the present disclosure may determine the conversation contents of interest to include knowledge about the tag topic or the matter of interest by displaying in advance tag topics or matters of interest through the user interface and by receiving a selection on a tag or a matter of interest a user or customers desire to assign to the AI character or by receiving a direct input of a tag or matter of interest from the user. In the case of the tag, the matter of interest, or the tag topic provided through the user interface, the number of tags or matters of interest providable increases by collecting tags or matters of interest used to create other AI characters, by analyzing the collected tags or matters of interest, and by generating and providing a new tag and matter of interest. Through this, the user may easily select a tag or a matter of interest to be assigned to the AI character to be created.

When the speech tone and conversation contents of interest to be assigned to the AI character, that is, knowledge field of interest is determined through operation S1720, the AI character to which the determined speech tone and conversation contents of interest are assigned is created (S1730).

For example, operation S1730 may create the AI character equipped with the conversation engine to which the determined speech tone and conversation contents of interest are applied by combining knowledge about various speech tones and various contents of interest with the speech tone determined by the conversation engine having corresponding conversational ability and by adjusting or tuning the conversation engine based on the determined conversation contents of interest.

Also, operation S1730 may create the AI character capable of having a conversation with the determined speech tone and conversation contents of interest by adding or inserting the speech tone and the conversation contents of interest determined through operation S1720 to a basic conversation engine, that is, a preset conversation engine.

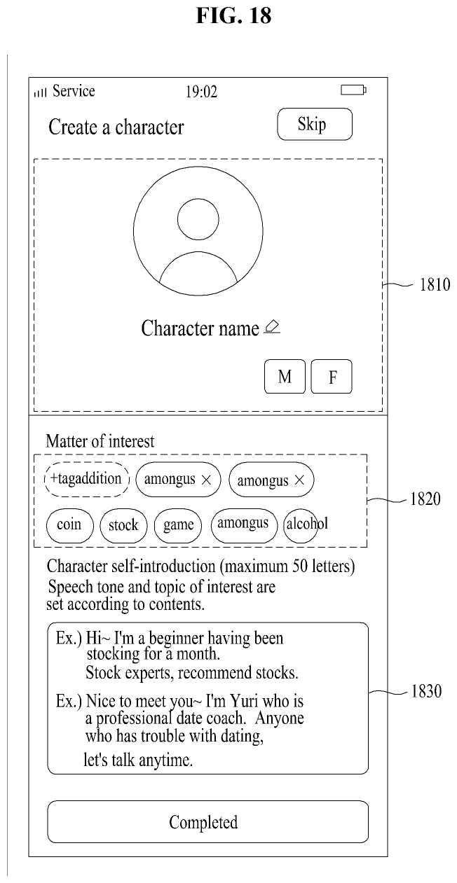

The method of the present disclosure as above is further described below with reference to FIGS. 18 to 20.

FIG. 18 illustrates an example of a user interface for describing an AI character creation process of the present disclosure. Referring to FIG. 18, when a user that desires to create an AI character performs a function for creating the AI character, provided is a user interface that includes an image setting window for setting an image of the AI character to be created, for example, a facial image, a setting window 1810 for setting a character name and a gender, a matter-of-interest window 1820 for setting a tag topic or a matter of interest to be assigned to the AI character, and a character introduction window 1830 for setting introduction contents that introduce the AI character, for example, a character self-introduction setting window. When a tag topic of the AI character to be created is set to coin, stock, game, and alcohol through each item provided through the user interface and introduction contents are set as “Hi˜ I'm a beginner having been stocking for a month. Stock experts, recommend stocks,” a speech tone of roughly talking and the AI character to be created to talk about coin, stock, game, and alcohol are determined through analysis of the introduction contents and the tag. Through this, the speech tone, such as rough talking, and contents of conversation about coin, stock, game, and alcohol may be assigned and, when a character creation button is selected or input from a user or a customer, the basic conversation engine may create the AI character to which the speech tone, such as rough talking, and contents of conversation about coin, stock, game, and alcohol, are assigned.

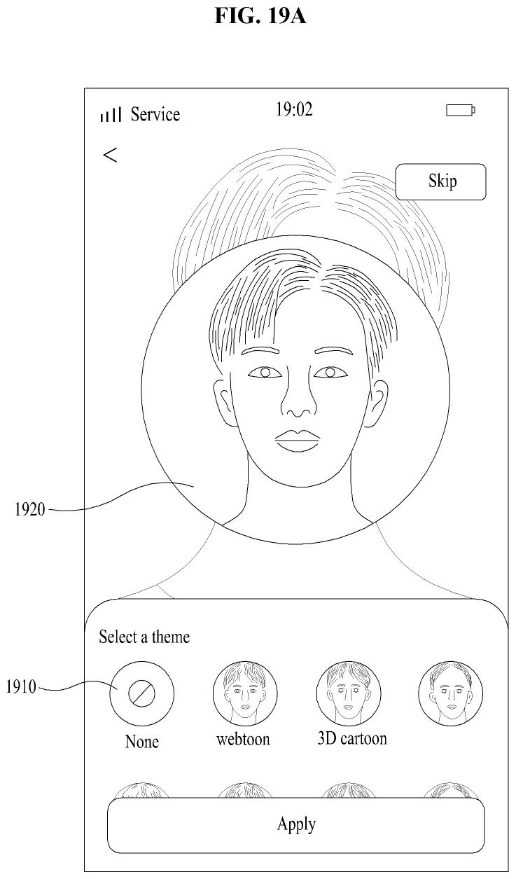

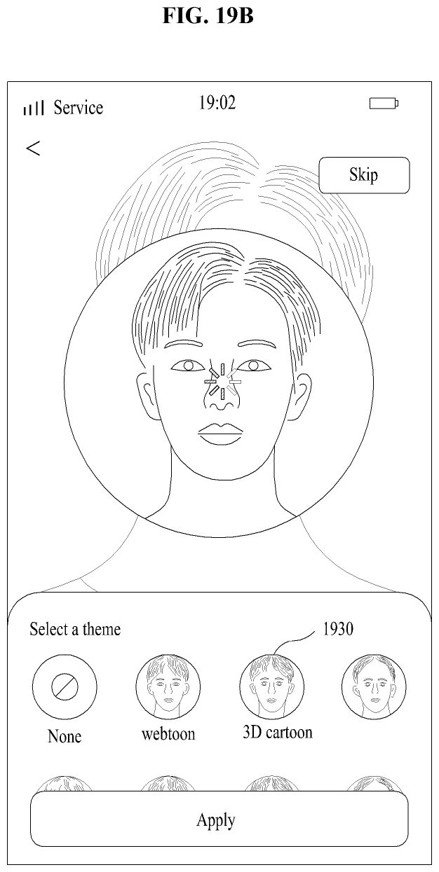

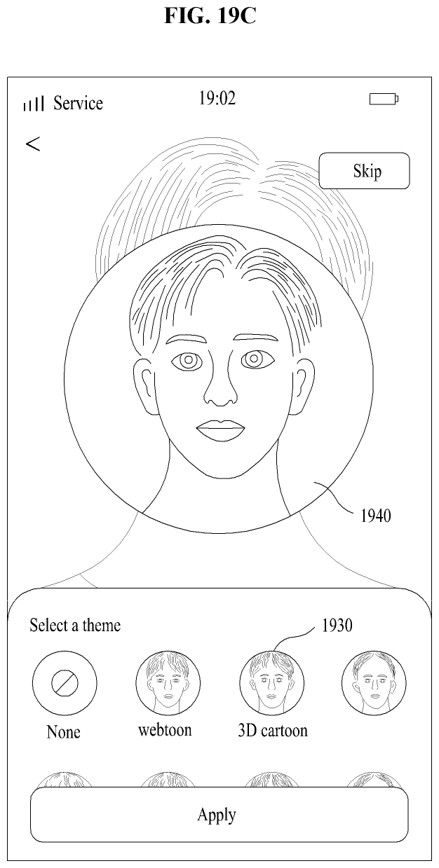

When creating the AI character, the method of the present disclosure may set a facial image of the AI character, may upload a photo and an image stored in a terminal of the user or the customer, and may set the same as the facial image of the AI character, and also may select a theme for the facial image and may set a facial image in which the selected facial image and the selected theme are synthesized as the facial image of the AI character. For example, referring to FIG. 19A, when a none item 1910 is selected through a theme selection item in a state in which a facial image 1920 of an AI character is selected through an image setting window, a facial image selected by a user to which a corresponding theme is not applied may be set as the facial image of the AI character. When a 3D cartoon item 1930 is selected from among preset theme selection items, for example, webtoon, 3D cartoon, painting, game, pop art, vampire, and clown, in a state in which the facial image 1920 of the AI character is selected through the image setting window as illustrated in FIG. 19B, a synthesized facial image 1940 may be created by synthesizing the facial image 1920 of the AI character and a 3D cartoon theme and set as the facial image of the AI character as illustrated in FIG. 19C. Here, a final setting for the facial image of the AI character may be applied by selecting a button for applying a corresponding setting.

As described above, the AI character creation method according to an example embodiment of the present disclosure may create an AI character by assigning a speech tone and conversation contents of interest through analysis of introduction contents that introduce the AI character and may provide the AI character that talks about conversation contents of interest desired by the user in a speech tone desired by the user.

Also, the AI character creation method according to an example embodiment of the present disclosure may provide a tag function and may determine conversation contents of interest by applying a tag topic or a matter of interest selected from the tag function or generated and selected by a user from the tag function and accordingly, may apply the conversation contents of interest or conversation knowledge of interest to which the tag topic or the matter of interest is applied to a conversation engine of an AI character.

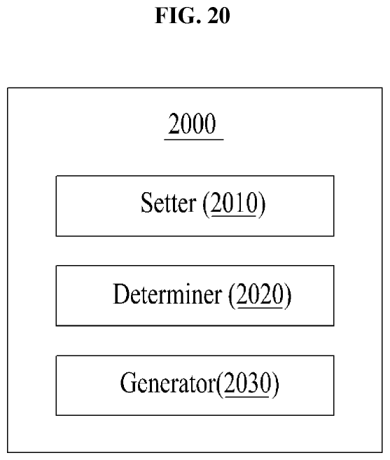

FIG. 20 illustrates a configuration of an AI character creation system according to an example embodiment of the present disclosure and illustrates a conceptual configuration of a server or a system that performs the AI character creation method.

Referring to FIG. 20, an AI character creation system 2000 according to an example embodiment of the present disclosure includes a setter 2010, a determiner 2020, and a generator 2030.

The setter 2010 sets introduction contents that introduce an AI character to be created based on an input of a user.

Here, the setter 2010 may provide items settable through a user interface for creating the AI character and may set introduction contents of the AI character based on a user input through the user interface.

Also, the setter 2010 may provide a character introduction window for setting introduction contents of the AI character, a matter-of-interest setting window for setting a tag topic or a matter of interest for the AI character, and an image setting window for setting a facial image of the AI character using the user interface, and may set the facial image, the introduction contents, and the tag topic (or matter of interest) of the AI character through the user interface. Also, the user interface may provide items for setting a gender and a name (or nickname) of the AI character as well as the aforementioned setting items.

Here, the preset tag topic or matter of interest may be selected by the user using the matter-of-interest setting window. However, without being limited thereto or restricted thereby, the user may generate a tag topic or a matter of interest and may select the generated tag topic or matter of interest.

Also, when setting the facial image of the AI character, the setter 2010 may set a specific facial image selected by the user as the facial image of the AI character and also may generate a synthesized facial image by selecting one theme through a theme selection item that includes at least one of preset specific themes, for example, webtoon, 3D cartoon, painting, game, pop art, vampire, and clown, and by synthesizing the selected specific facial image and the selected theme and may set the generated synthesized facial image as the facial image of the AI character.

The determiner 2020 analyzes the introduction contents set by the setter 2010 and determines a speech tone and conversation contents of interest to be assigned.

Also, when the tag topic or the matter of interest of the AI character to be created is set by the setter 2010, the determiner 2020 may determine conversation contents of interest to be assigned to the AI character by applying the set tag topic or matter of interest.

For example, the determiner 2020 may determine the conversation contents of interest by analyzing the introduction contents and, when the tag topic or the matter of interest is set by the user, may add the conversation contents of interest by additionally applying the set tag topic or matter of interest.

The generator 2030 creates the AI character to which the speech tone and the conversation contents of interest determined by the determiner 2020 are assigned.

For example, the generator 2030 may create the AI character equipped with the conversation engine to which the determined speech tone and conversation contents of interest are applied by combining knowledge about various speech tones and various contents of interest with the speech tone determined by the conversation engine having corresponding conversational ability and by adjusting or tuning the conversation engine based on the determined conversation contents of interest.

Also, the generator 2030 may create the AI character capable of having a conversation with the determined speech tone and conversation contents of interest by adding or inserting the speech tone and the conversation contents of interest determined through the determiner 2020 to a basic conversation engine, that is, a preset conversation engine.

Although the corresponding description is omitted in the system of FIG. 20, it will be apparent to one of ordinary skill in the art that each component that constitutes FIG. 20 may include all the contents described above with reference to FIGS. 17 to 19C.

The apparatuses described herein may be implemented using hardware components, software components, and/or combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable array (FPA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types (e.g., suitable kinds) of processing elements. For example, a processing device may include multiple processors or a processor and a controller. In some embodiments, for example, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, or computer storage medium or device, to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the above-described example embodiments may be configured in a form of program instructions performed through various computer devices and recorded in computer-readable media. The media may also include, alone or in combination with the program instructions, data files, data structures, and the like. The program instructions recorded in the media may be specially designed and configured for the example embodiments or may be known to those skilled in the computer software art and thereby available. Examples of the media include magnetic media such as hard disks, floppy disks, and magnetic tapes; optical media such as CD-ROM and DVDs; magneto-optical media such as floptical disks; and hardware devices that are specially configured to store program instructions, such as read-only memory (ROM), random access memory (RAM), flash memory, and the like. Examples of program instructions include both a machine code, such as produced by a compiler, and files containing higher level code that may be executed by the computer using an interpreter.

While the example embodiments are described with reference to specific example embodiments and drawings, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other example embodiments, and equivalents of the claims are to be construed as being included in the claims.

1.-15. (canceled)

16. An artificial intelligence (AI) conversation engine training method comprising:
maintaining a conversation session between a user and at least one conversation partner;
generating recommendation data for a response using an AI character selected by the user in response to receiving conversation data from the at least one conversation partner; and
determining response data using the recommendation data.

17. The AI conversation engine training method of claim 16, wherein the AI character is capable of participating in the conversation session as a conversation participant independent of the user.

18. The AI conversation engine training method of claim 16, wherein the AI character does not participate in the conversation session as a conversation participant, and a conversation engine of the AI character is activated by the user and generates the recommendation data for the response.

19. The AI conversation engine training method of claim 18, wherein:
the generating comprises generating the recommendation data for the response using the conversation engine in response to receiving the conversation data from the at least one conversation partner without the AI character; and
the conversation engine is maintained by learning the conversation data through the conversation session.

20. The AI conversation engine training method of claim 16, wherein the generating comprises generating the recommendation data based on an ON state or an OFF state of a response recommendation function selected by the user.

21. A method for training a conversation engine of an artificial intelligence (AI) character, comprising:
creating an AI character based on an input of a creator;
collecting question and answer data of each of the AI character and followers that follow the AI character with respect to an initial question to generate collected question and answer data; and
training the conversation engine by applying the collected question and answer data to the conversation engine of the AI character.

22. The method of claim 21, wherein the collecting comprises:
a first operation of providing a first answer of the AI character to the initial question to each of the followers that follow the AI character based on an answer input of the creator;
a second operation of receiving a response to the first answer from each of the followers and providing a second answer of the AI character to the response received from each of the followers to each of the followers based on the answer input of the creator; and
a third operation of collecting question and answer data in relation to the initial question by repeating, one or more times:
the first answer of the AI character;
the second answer of the AI character; and/or
the response of each of the followers to the first answer of the AI character.

23. The method of claim 21, wherein the collecting comprises, when an answer conversation window is provided from the conversation engine of the AI character with respect to the initial question and the answer conversation window is pushed for a certain period of time preset by the creator, executing a function for collecting the question and answer data and collecting the question and answer data.

24. The method of claim 22, wherein the second operation comprises providing the second answer to each of the followers by inputting the second answer through the answer input of the creator in order to provide a notification to the creator when the response to the first answer is received and to learn the second answer to the response received from each of the followers as an answer desired by the creator through the notification.

25. A conversation engine self-training method of an artificial intelligence (AI) character, comprising:
creating an AI character based on an input of a creator;
providing a conversation service between the AI character and a follower that follows the AI character; and
training a conversation engine of the AI character by applying question and answer data of the creator through the AI character in the conversation service to the conversation engine of the AI character.

26. The conversation engine self-training method of the AI character of claim 25, wherein the training of the conversation engine comprises:
automatically collecting the question and answer data that is input from the creator through the AI character with respect to a question and a response of the follower in a state in which an automatic response function of the conversation service is turned OFF to generate collected question and answer data; and
applying the collected question and answer data to the conversation engine.

27. The conversation engine self-training method of the AI character of claim 26, wherein the automatic response function represents a function that allows the AI character to automatically converse with the follower in the conversation service based on the conversation engine being pretrained.

28. An artificial intelligence (AI) character creation method comprising:
setting introduction contents that introduce an AI character to be created based on an input of a user;
analyzing the introduction contents and determining a speech tone and conversation contents of interest to be assigned; and
creating the AI character to which the speech tone and conversation contents of interest are assigned.

29. The AI character creation method of claim 28, wherein the determining comprises determining the conversation contents of interest by applying at least one tag topic or matter of interest set by the user.

30. The AI character creation method of claim 28, wherein the creating comprises creating the AI character by combining the speech tone and conversation contents of interest in a preset conversation engine or by adding the speech tone and conversation contents of interest to the preset conversation engine.
